(19) United States
(12) Patent Application Publication
(10) Pub. No.: US 2026/0012952 A1
(43) Pub. Date: Jan. 8, 2026

(54) SMALL DATA TRANSMISSION

(71) Applicant: Samsung Electronics Co., Ltd., Suwon-si (KR)

(72) Inventors: Anil Agiwal, McKinney, TX (US); Kyeongin Jeong, Frisco, TX (US)

(21) Appl. No.: 19/248,378

(22) Filed: Jun. 24, 2025

Related U.S. Application Data
(60) Provisional application No. 63/667,402, filed on Jul. 3, 2024.
(60) Provisional application No. 63/668,053, filed on Jul. 5, 2024.
(60) Provisional application No. 63/733,326, filed on Dec. 12, 2024.

(51) Int. Cl. H04W 72/21; H04B 17/318; H04W 72/232

(52) U.S. Cl. CPC H04W 72/21; H04B 17/328; H04W 72/232

(57) ABSTRACT

A user equipment (UE) includes a transceiver. The transceiver is configured to receive, from a base station (BS), a physical uplink control channel (PUCCH) configuration for small data transmission (SDT), the PUCCH configuration for SDT configuring one or more PUCCH resources. The UE also includes a processor operably coupled to the transceiver. The processor is configured to determine whether each of at least one criterion to initiate an SDT procedure is met. The processor is also configured to, in response to a determination that each of the at least one criterion to initiate the SDT procedure is met, select a PUCCH resource from the one or more PUCCH resources, and cause the transceiver to transmit, to the BS, an SDT initiation indication in the selected PUCCH resource.

### CROSS-REFERENCE TO RELATED APPLICATIONS AND CLAIM OF PRIORITY

This application claims priority under 35 U.S.C. § 119 (e) to U.S. Provisional Patent Application No. 63/667,402 filed on Jul. 3, 2024, U.S. Provisional Patent Application No. 63/668,053 filed on Jul. 5, 2024, and U.S. Provisional Patent Application No. 63/733,326 filed on Dec. 12, 2024. The above-identified provisional patent applications are hereby incorporated by reference in their entirety.

### TECHNICAL FIELD

This disclosure relates generally to wireless networks. More specifically, this disclosure relates to small data transmission.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for small data transmission.

In one embodiment, a user equipment (UE) is provided. The UE includes a transceiver. The transceiver is configured to receive, from a base station (BS), a physical uplink control channel (PUCCH) configuration for small data transmission (SDT), the PUCCH configuration for SDT configuring one or more PUCCH resources. The UE also includes a processor operably coupled to the transceiver. The processor is configured to determine whether each of at least one criterion to initiate an SDT procedure is met. The processor is also configured to, in response to a determination that each of the at least one criterion to initiate the SDT procedure is met, select a PUCCH resource from the one or more PUCCH resources, and cause the transceiver to transmit, to the BS, an SDT initiation indication in the selected PUCCH resource.

In another embodiment, a BS is provided. The BS includes a processor, and a transceiver operably coupled to the processor. The transceiver is configured to transmit, to a UE, a PUCCH configuration for SDT, the PUCCH configuration for SDT configuring one or more PUCCH resources. The transceiver is also configured to receive, from the UE, an SDT initiation indication in one of the one or more PUCCH resources.

In yet another embodiment, a method of operating a UE is provided. The method includes receiving, from a BS, a PUCCH configuration for SDT, the PUCCH configuration for SDT configuring one or more PUCCH resources, and determining whether each of at least one criterion to initiate an SDT procedure is met. The method also includes, in response to a determination that each of the at least one criterion to initiate the SDT procedure is met, selecting a PUCCH resource from the one or more PUCCH resources, and transmitting, to the BS, an SDT initiation indication in the selected PUCCH resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIGS. 4A-4B illustrate examples of PF distribution according to embodiments of the present disclosure;

FIG. 5 illustrates an example procedure for small data transmission in a cell according to embodiments of the present disclosure;

FIGS. 6A-6B illustrate another example procedure for small data transmission in a cell according to embodiments of the present disclosure;

FIG. 7 illustrates an example procedure for a resource reconfiguration for configured grant based small data transmission according to embodiments of the present disclosure;

FIG. 8 illustrates an example procedure for a TA reacquisition for small data transmission in a cell according to embodiments of the present disclosure;

FIG. 9 illustrates an example procedure to transmit and receive paging according to embodiments of the present disclosure;

FIG. 10 illustrates another example procedure to transmit and receive paging according to embodiments of the present disclosure;

FIG. 11 illustrates another example procedure to transmit and receive paging according to embodiments of the present disclosure;

FIG. 12 illustrates an example method for small data transmission according to embodiments of the present disclosure; and

FIG. 13 illustrates another example method for small data transmission according to embodiments of the present disclosure.

### DETAILED DESCRIPTION

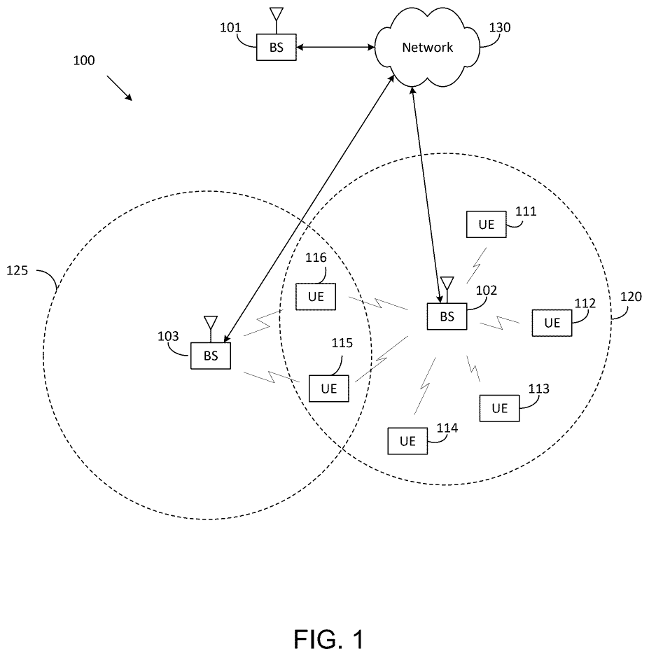

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for small data transmission. In certain embodiments, one or more of the gNBs 101-103 includes circuitry, programing, or a combination thereof, to support small data transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

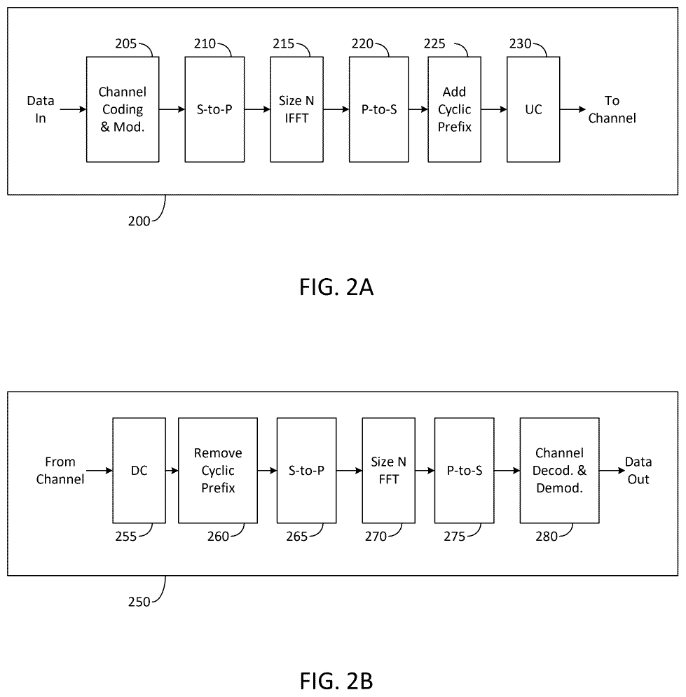

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support small data transmission as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

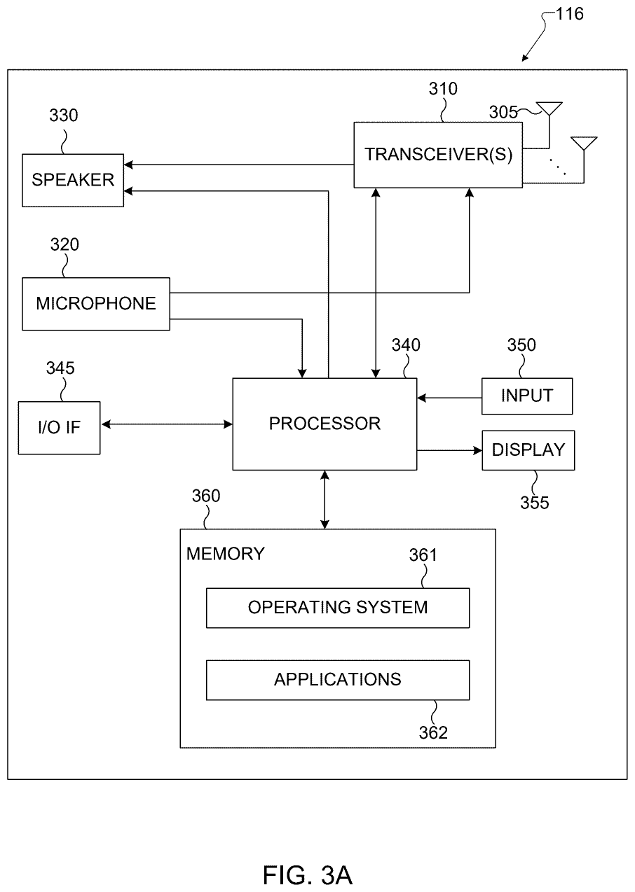

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for small data transmission as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support small data transmission as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation (e.g., 5G, beyond 5G (B5G), 6G) wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-Inactivity Timer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For synchronization signal block (SSB) and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or positioning SIBs (posSIBs) having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RR (Reconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC_CONNECTED state. Several types of RA procedures are supported, such as contention based random access, and contention free random access. Each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), a UE can be in one of the following RRC states: RRC_IDLE, RRC INACTIVE and RRC_CONNECTED. Paging allows the network to reach UEs in the RRC_IDLE and in RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with a paging radio network terminal identifier (P-RNTI) on the PDCCH, but while the former is sent on a paging common logical channel (PCCH) (a transport block [TB] carrying the paging message is transmitted over the PDSCH [Physical downlink shared channel])), the latter is sent over the PDCCH directly.

While in the RRC_IDLE state, the UE monitors the paging channels for core network (CN)-initiated paging. While in the RRC_INACTIVE state, the UE monitors paging channels for radio access network (RAN)-initiated paging and CN-initiated paging. A UE need not monitor paging channels continuously though. Paging discontinuous reception (DRX) is defined where the UE in the RRC_IDLE or RRC_INACTIVE state is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams, and thus the selection of the beam(s) for the reception of the paging message and Short Message is up to UE implementation. The paging message is the same for both RAN initiated paging and CN initiated paging. The UE initiates the RRC Connection Resume procedure upon receiving RAN initiated paging. If the UE receives a CN initiated paging in the RRC_INACTIVE state, the UE moves to the RRC_IDLE state and informs the non-access stratum (NAS).

The PF and PO for paging are determined (by the UE and base station e.g., gNB) by the following formulae:
System frame number (SFN) for the PF is determined by:

$$( SFN + PF\_offset ) mod T = {( T div N )}^{*} ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceld=0 is configured for pagingSearchSpace, the PDCCH monitoring occasions for paging are the same as for RMSI (or SIB1).

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceld other than 0 is configured for pagingSearchSpace, the UE monitors the (i_s+1)^{th}PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the Kth transmitted SSB, where x=0,1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th}value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:

If the UE operates in enhanced DRX (eDRX):
5G-S-TMSI (5G serving temporary mobile subscriber identity) mod 4096
   otherwise:
5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and i_s formulas above.

In the next generation wireless communication system (e.g., 5G, beyond 5G, 6G), the Radio Resource Control (RRC) protocol may be in one of the following states: RRC_IDLE, RRC INACTIVE, and RRC_CONNECTED. A UE is either in an RRC_CONNECTED state or in an RRC_INACTIVE state when an RRC connection has been established. If this is not the case, (i.e., no RRC connection is established), the UE is in an RRC_IDLE state. The RRC states can further be characterized as follows:

In the RRC_IDLE state, a UE specific DRX may be configured by upper layers. The UE monitors short messages transmitted with P-RNTI over DCI. The UE monitors a paging channel for CN paging using 5G-S-TMSI. The UE performs neighboring cell measurements and cell (re-) selection. The UE acquires system information and can send SI requests (if configured). The UE performs logging of available measurements together with location and time for logged measurement configured UEs.

In the RRC_INACTIVE state, a UE specific DRX may be configured by upper layers or by RRC layer. The UE stores the UE inactive access stratum (AS) context. A RAN-based notification area is configured by RRC layer. The UE monitors short messages transmitted with P-RNTI over DCI. The UE monitors a paging channel for CN paging using 5G-S-TMSI and RAN paging using full I-RNTI. The UE performs neighboring cell measurements and cell (re-) selection. The UE performs RAN-based notification area updates periodically and when moving outside the configured RAN-based notification area. The UE acquires system information and can send SI requests (if configured). The UE performs logging of available measurements together with location and time for logged measurement configured UEs.

In the RRC_CONNECTED state, the UE stores the AS context and transfer of unicast data to/from the UE takes place. The UE monitors short messages transmitted with P-RNTI over DCI, if configured. The UE monitors control channels associated with the shared data channel to determine if data is scheduled for the UE. The UE provides channel quality and feedback information. The UE performs neighboring cell measurements and measurement reporting. The UE acquires system information.

In the RRC_CONNECTED state, the network may initiate suspension of the RRC connection by sending RRCRelease with suspend configuration. When the RRC connection is suspended, the UE stores the UE Inactive AS context and any configuration received from the network, and transits to the RRC_INACTIVE state. If the UE is configured with an SCG, the UE releases the SCG configuration upon initiating a RRC connection resume procedure. The RRC message to suspend the RRC connection is integrity protected and ciphered.

The resumption of a suspended RRC connection is initiated by upper layers when the UE needs to transit from the RRC_INACTIVE state to the RRC_CONNECTED state or by the RRC layer to perform a RAN notification area (RNA) update or by RAN paging from an NG-RAN. When the RRC connection is resumed, the network configures the UE according to the RRC connection resume procedure based on the stored UE Inactive AS context and any RRC configuration received from the network. The RRC connection resume procedure re-activates AS security and re-establishes SRB(s) and DRB(s). In response to a request to resume the RRC connection, the network may resume the suspended RRC connection and send the UE to the RRC_CONNECTED state, or reject the request to resume and send the UE to the RRC_INACTIVE state (with a wait timer), or directly re-suspend the RRC connection and send the UE to the RRC_INACTIVE state, or directly release the RRC connection and send the UE to the RRC_IDLE state, or instruct the UE to initiate NAS level recovery (in this case the network sends an RRC setup message).

In the next generation wireless communication system (e.g., 5G, beyond 5G, 6G), mobile originated small data transmission (SDT) procedure is also supported in the RRC_INACTIVE state. SDT is a procedure allowing data and/or signaling transmission while remaining in the RRC_INACTIVE state (i.e., without transitioning to the RRC_CONNECTED state). SDT is enabled on a radio bearer basis and can be initiated either by the UE in case of Mobile Originated SDT (MO-SDT) or by the network in case of Mobile Terminated SDT (MT-SDT). MO-SDT is initiated by the UE only if less than or equal to a configured amount of UL data awaits transmission across all radio bearers for which SDT is enabled, the DL RSRP is above a configured threshold, and a valid SDT resource is available. MT-SDT is initiated by the network with an indication to the UE in a paging message when DL data awaits transmission for radio bearers configured for SDT. Based on the indication, the UE initiates the MT-SDT only if the DL RSRP is above a configured threshold. When MT-SDT is initiated by the UE, a resume cause indicating MT-SDT is included in the RRCResumeRequest/RRCResumeRequest1. The maximum duration the SDT procedure can last is dictated by a SDT failure detection timer that is configured by the network. The network can enable MO-SDT, MT-SDT, or both in a cell.

An SDT procedure is initiated with either a transmission over a RACH (configured via system information) or over Type 1 configured grant (CG) resources (configured via dedicated signaling in RRCRelease). The SDT resources can be configured on an initial BWP for both the RACH and CG. The RACH and CG resources for SDT can be configured on either or both of NUL and SUL carriers. The CG resources for SDT are valid only within the PCell of the UE when the RRCRelease with suspend indication is received. The CG resources are associated with one or multiple SSB(s). For RACH, the network can configure 2-step and/or 4-step RA resources for MO-SDT. When both 2-step and 4-step RA resources for MO-SDT are configured, the UE selects the RA type. If MT-SDT procedure is initiated over RACH, only the RACH resources not configured for SDT can be used by the UE. CFRA is not supported for SDT over RACH.

Once initiated, the SDT procedure is either:
successfully completed after the UE is directed to the RRC_IDLE state (via RRCRelease) or to continue in the RRC_INACTIVE state (via RRCRelease or RRCReject) or directed to the RRC_CONNECTED state (via RRCResume or RRCSetup); or
unsuccessfully completed upon cell re-selection, expiry of the SDT failure detection timer, a MAC entity reaching a configured maximum PRACH preamble transmission threshold, an RLC entity reaching a configured maximum retransmission threshold, or integrity check failure while SDT procedure is ongoing, or expiry of SDT-specific timing alignment timer or configuredGrantTimer while SDT procedure is ongoing over CG and the UE has not received a response from the network after the initial PUSCH transmission.

Upon unsuccessful completion of the SDT procedure, the UE transitions to the RRC_IDLE state. For SDT, the network should not send an RRCReject in response to RRCResumeRequest/RRCResumeRequest1 if DL data over any radio bearer configured for SDT is transmitted.

The initial PUSCH transmission during the SDT procedure includes at least the CCCH message. When using CG resources for initial SDT transmission, the UE can perform autonomous retransmission of the initial transmission if the UE does not receive confirmation from the network (a dynamic UL grant or DL assignment) before a configured timer expires. After the initial PUSCH transmission, subsequent transmissions are handled differently depending on the type of resource used to initiate the SDT procedure:
When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation (a dynamic UL grant or DL assignment) for the initial PUSCH transmission from the network. For subsequent UL transmission, the UE cannot initiate re-transmission over a CG resource.
When using RACH resources, the network can schedule subsequent UL and DL transmissions using dynamic UL grants and DL assignments, respectively, after the completion of the RA procedure.

When an SDT procedure is initiated, AS security is applied for all the radio bearers enabled for SDT.

While the SDT procedure is ongoing, if data appears in a buffer of any radio bearer not enabled for SDT, the UE initiates a transmission of a non-SDT data arrival indication using UEAssistanceInformation message to the network and, if available, includes the resume cause.

An SDT procedure over CG resources can only be initiated with valid UL timing alignment. The UL timing alignment is maintained by the UE based on an SDT-specific timing alignment timer configured by the network via dedicated signaling and, for initial configured grant-small data transmission (CG-SDT) transmission, also by the DL RSRP of a configured number of highest ranked SSBs which are above a configured RSRP threshold. Upon expiry of the SDT-specific timing alignment timer, the CG resources are released while maintaining the CG resource configuration.

Logical channel restrictions configured by the network while in the RRC_CONNECTED state and/or in an RRCRelease message for radio bearers enabled for SDT, if any, are applied by the UE during an SDT procedure.

The network may configure the UE to apply robust header compression (ROHC) continuity for SDT either when the UE initiates SDT in the PCell of the UE when the RRCRelease with suspend indication was received or when the UE initiates SDT in a cell of its RNA.

For an SDT procedure over CG resources, the network may configure a maximum time duration until the next valid CG occasion for an initial CG-SDT transmission based on which the UE decides whether an SDT procedure over CG resources can be initiated. The maximum time duration is configured per logical channel for MO-SDT and per UE for MT-SDT.

In existing wireless networks, dedicated Type 1 CG resources configured for SDT leads to resource wastage, as each resource is large enough to carry resume request and UL data. These resources are periodically configured and not used until UL data arrival in the UE. Various embodiments of the present disclosure provide mechanisms to reduce such resource wastage.

In existing wireless networks, configured CG-SDT resources in a cell are released when a CG-SDT time alignment timer (CG-SDT-TAT) expires. As a result, the UE relies on contention based SDT procedure, resulting in more delay and energy consumption. In existing wireless networks, configured CG-SDT resources in a cell are also released when the UE reselects to another cell. As a result, the UE relies on contention based SDT procedure in the new cell, resulting in more delay and energy consumption. Various embodiments of the present disclosure provide mechanisms for reduced delay and energy consumption during SDT in a new cell.

In existing wireless networks, multiple paging frames configured by the network are uniformly distributed in time. UEs are distributed across these paging frames. A UE monitors its PO in its PF every DRX cycle.

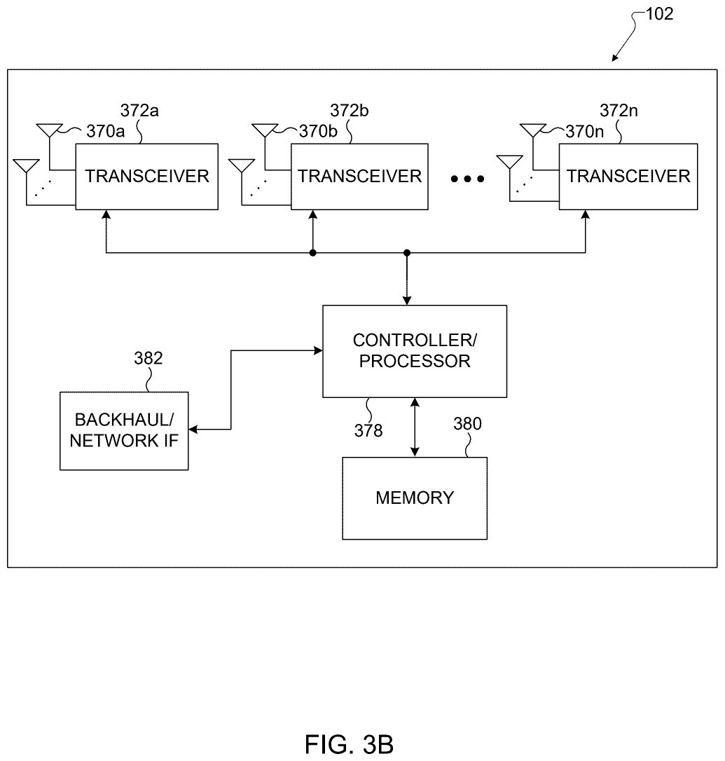

FIGS. 4A-4B illustrate examples 400 and 450 of PF distribution according to embodiments of the present disclosure. The embodiments of PF distribution of FIGS. 4A-4B are for illustration only. Different embodiments of PF distributions could be used without departing from the scope of this disclosure.

As shown in example 400 of FIG. 4A, a PF occurs every 4 radio frames. There are 4 PFs in each period of 32 radio frames. UEs in the cell are distributed to these PFs based on UE_ID. The distributed PFs lead to frequent wakeup by the network to deliver paging, resulting in increased energy consumption.

Example 450 shown in FIG. 4B is an approach of bundling PFs (which may also be referred to as paging adaptation) to reduce multiple wake ups. Frequent transmission of signals such as SSBs/PEIs that aid in reception of paging can also be minimized with bundling.

Although FIGS. 4A-4B illustrate examples 400 and 450 of PF distribution, various changes may be made to FIG. 4A and/or 4B. For example, various changes to the number of PFs could be made, various changes to the number of radio frames could be made, etc. according to particular needs. In another example, one PF may be configured per DRX cycle and several POs can be configured for the PF, resulting in PO clustering/bundling at the beginning of the DRX cycle. In another example, multiple PFs may be configured per DRX cycle with large intervals between the PFs and several POs can be configured every PF, resulting in PO clustering/bundling at an interval equal to the gap between PFs.

A UE can be configured with a UE specific DRX cycle for paging by an upper layer such as the NAS and/or by RRC. The default DRX cycle for paging is signaled to the UE by system information. The UE specific DRX cycle can be smaller or larger than the default DRX cycle. In existing wireless networks, the UE applies T=min (Default DRX cycle, UE specific DRX cycle) for determining its PF/PO.

When POs are clustered/bundled/adapted at the beginning of the default DRX cycle and Default DRX cycle is larger than UE specific DRX cycle, the current method of applying T=min (Default DRX cycle, UE specific DRX cycle) will lead to situations where a UE monitors a PF/PO which does not exist. For example, assume the default DRX cycle is 128 radio frames and the UE specific DRX cycle is 32 radio frames. In this case the UE determines its PF/PO every 32 radio frames, whereas from the network point of view, PFs/POs exist only every 128 radio frames.

One approach to resolve this would be to apply T=max (Default DRX cycle, UE specific DRX cycle) or T=Default DRX cycle when POs are clustered/bundled/adapted. However, this leads to increased paging latency. Various embodiments of the present disclosure provided mechanisms for PO clustering/bundling/adaptation with reduced paging latency.

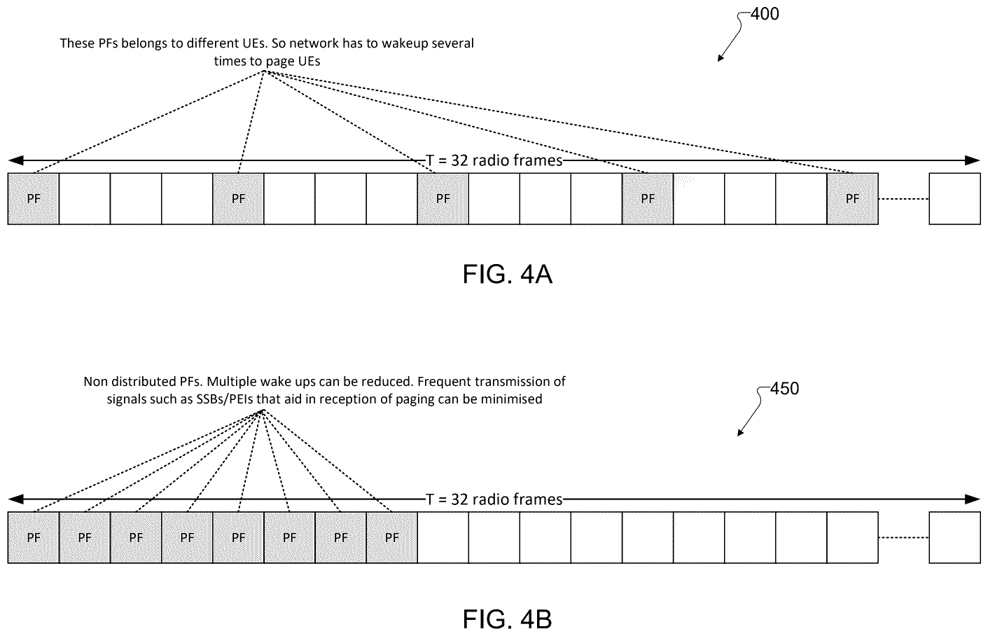

FIG. 5 illustrates an example procedure 500 for small data transmission in a cell according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for small data transmission in a cell could be used without departing from the scope of this disclosure.

In the example of FIG. 5, procedure 500 begins at operation 510. At operation 510, a UE 502 (which may be similar or identical to UE 116 of FIG. 1) receives a configuration of PUCCH resources for small data transmission from the network 504 (e.g., from a base station of the cell, gNB of the cell etc.).

In some embodiments, the configuration of PUCCH resources for small data transmission can be received in an RRCRelease message (or an RRCRelease message with suspend config). In some embodiments, the configuration of PUCCH resources for small data transmission can be received in an RRC message.

In some embodiments, the configuration of PUCCH resources for small data transmission can be received for a NUL carrier and/or the configuration of PUCCH resources for small data transmission can be received for an SUL carrier. In these embodiments, the configuration of PUCCH resources for small data transmission can be separately received for the NUL and the SUL carriers.

In some embodiments, the configuration of PUCCH resources for small data transmission can indicate PUCCH occasions/resources, a periodicity at which PUCCH an occasion/resource occurs in the time domain, frequency domain (PRBs/REs) resource information of a PUCCH occasion/resource, subcarrier spacing associated with PUCCH resources, a list of one or more SSBs/CSI RSs associated with configuration of PUCCH resources for small data transmission, the number of SSBs/CSI RSs per PUCCH occasion, a threshold for SSB/CSI RS selection, etc. PUCCH occasions signaled by the configuration can be mapped to SSBs/CSI RSs associated with the configuration. For example, if the number of SSBs/CSI RSs per PUCCH occasion is 2 and SSB1/CSI RS1 to SSB8/CSI RS8 are associated with the configuration of PUCCH resources for small data transmission, SSB1/CSI RS1 and SSB2/CSI RS2 are associated with a first PUCCH occasion, SSB3/CSI RS3 and SSB4/CSI RS4 are associated with a second PUCCH occasion, SSB5/CSI RS5 and SSB6/CSI RS6 are associated with third PUCCH occasion, SSB7/CSI RS7 and SSB8/CSI RS8 are associated with a fourth PUCCH occasion, etc. In another example, if the number of SSBs/CSI RSs per PUCCH occasion is 1 and SSB1/CSI RS1 to SSB 8/CSI RS8 are associated with the configuration of PUCCH resources for small data transmission, SSB1/CSI RS1 is associated with a first PUCCH occasion, SSB2/CSI RS2 is associated with a second PUCCH occasion, SSB3/CSI RS3 is associated with a third PUCCH occasion, SSB4/CSI RS4 is associated with fourth a PUCCH occasion, etc.

In some embodiments, a PUCCH resource can be small enough to carry 1 bit information (e.g., an SDT indication) or indicate an SDT indication.

At operation 520, UE 502 initiates the PUCCH based small data transmission.

In some embodiments, for MO-SDT (i.e., UL data arrives for one or more RBs configured for SDT):
If data volume of the pending UL data across all RBs configured for SDT is less than or equal to sdt-DataVolume Threshold; and
if the RSRP of the downlink pathloss reference is higher than sdt-RSRP-Threshold or if sdt-RSRP-Threshold is not configured:
   If the Serving Cell (i.e., the cell where UE 502 is currently camped) is configured with a supplementary uplink and if the RSRP of the downlink pathloss reference is less than rsrp-ThresholdSSB-SUL, UE 502 selects the SUL carrier. Otherwise, 502 selects the NUL carrier.
   If PUCCH resources for small data transmission are configured for the selected UL carrier and UE 502 has valid TA in the first available PUCCH occasion for initial transmission on the PUCCH, and if at least one SSB/CSI-RS configured for PUCCH resources for small data transmission with a synchronization signal-reference signal received power (SS-RSRP)/channel state information reference signal received power (CSIRS-RSRP) above a threshold (the threshold can be configured by network 504) is available, UE 502 initiates PUCCH based small data transmission.
   Note that if PUCCH resources for small data transmission are received from a Cell “A” and UE 502's current camped cell is not Cell A, the PUCCH resources for small data transmission are not considered configured in the currently camped cell.

In some embodiments, for MT-SDT (i.e., and MT-SDT indication is received from network), if the RSRP of the downlink pathloss reference is higher than sdt-RSRP-Threshold or if sdt-RSRP-Threshold is not configured:
If the Serving Cell (i.e., cell where UE 502 is currently camped) is configured with a supplementary uplink and if the RSRP of the downlink pathloss reference is less than rsrp-ThresholdSSB-SUL, UE 502 selects the SUL carrier. Otherwise, UE 502 selects the NUL carrier.
If PUCCH resources for small data transmission are configured for the selected UL carrier and UE 502 has valid TA in the first available PUCCH occasion for initial transmission on the PUCCH, and if at least one SSB/CSI-RS configured for PUCCH resources for small data transmission with SS-RSRP/CSIRS-RSRP above a threshold (the threshold can be configured by network 504) is available, UE 502 initiates PUCCH based small data transmission.
Note that if PUCCH resources for small data transmission are received from a Cell “A” and UE 502's current camped cell is not Cell A, PUCCH resources for small data transmission are not considered configured in the currently camped cell.

In some embodiments, upon the reception of PUCCH resources for small data transmission, UE 502 stores the current RSRP of the downlink pathloss reference for TA validation. TA for initial transmission on the PUCCH for small data transmission is valid when the following conditions are fulfilled:
The RSRP values for the stored downlink pathloss reference and the current downlink pathloss reference are valid; and
compared to the stored downlink pathloss reference RSRP value, the current RSRP value of the downlink pathloss reference has not increased/decreased by more than pucch-SDT-RSRP-Change Threshold, if configured; and
pucch-SDT-Time AlignmentTimer is running (UE 502 may start the pucch-SDT-Time AlignmentTimer when the PUCCH resources for small data transmission are received).

UE 502 selects a PUCCH occasion. In some embodiments, UE 502 selects the (first available) PUCCH occasion associated with an SSB/CSI-RS with SS-RSRP/CSIRS-RSRP above a threshold. UE 502 transmits the SDT indication in the selected PUCCH occasion. In some embodiments, UE 502 may transmit the SDT indication and a UE identity (e.g., a cell-radio network temporary identifier [C-RNTI] or S-TMSI) in the selected PUCCH occasion. In some embodiments, UE 502 may include information about the UL data in UE 502's buffer (e.g., a buffer status report [BSR]) in the PUCCH occasion.

At operation 530, upon receiving the SDT indication in the PUCCH occasion, network 504 (e.g., a base station of the cell, gNB of the cell etc.) identifies the UE 502, as the PUCCH occasion/resource in which the SDT indication is received was assigned to the UE 502. Network 504 (e.g., a base station of the cell, gNB of the cell etc.) may transmit one or more PDCCHs addressed to C-RNTI (the C-RNTI of the identified UE) during the SDT procedure.

A PDCCH addressed to the C-RNTI may schedule an UL grant to UE 502. At operation 540, UE 502 transmits UL data (from SDT RB(s) and/or BSR) in the received UL grant. The UL data can be integrity protected. In some embodiments, UE 502 may transmit an RRCResumeRequest (with resumeMAC-I) in the first UL grant. In some embodiments, UE 502 may transmit an RRCSetupRequest in the first UL grant.

At operation 550, a PDCCH addressed to the C-RNTI may schedule a DL TB to UE 502. At operation 560, UE 502 receives DL data (from SDT RB(s)) in the received DL TB. UL data can be integrity protected.

At operation 570, network 504 (e.g., a base station of the cell, gNB of the cell, etc.) sends an RRCRelease message to terminate the SDT procedure. UE 502 terminates the SDT procedure.

In some embodiments, in procedure 500 of FIG. 5, a PUCCH resource/occasion can be a CG resource/CG occasion.

In some embodiments, after transmitting the SDT indication in the PUCCH occasion, if the UE does not receive a PDCCH addressed to a C-RNTI (or if the UE does not receive a PDCCH addressed to a C-RNTI within a pre-defined/configured time or window), the UE may select the PUCCH occasion in a similar manner as the earlier PUCCH occasion selection and transmit the SDT indication.

Although FIG. 5 illustrates one example procedure 500 for small data transmission in a cell, various changes may be made to FIG. 5. For example, while shown as a series of operations, various operations in FIG. 5 could overlap, occur in parallel, occur in a different order, occur any number of times, be omitted, or replaced by other operations.

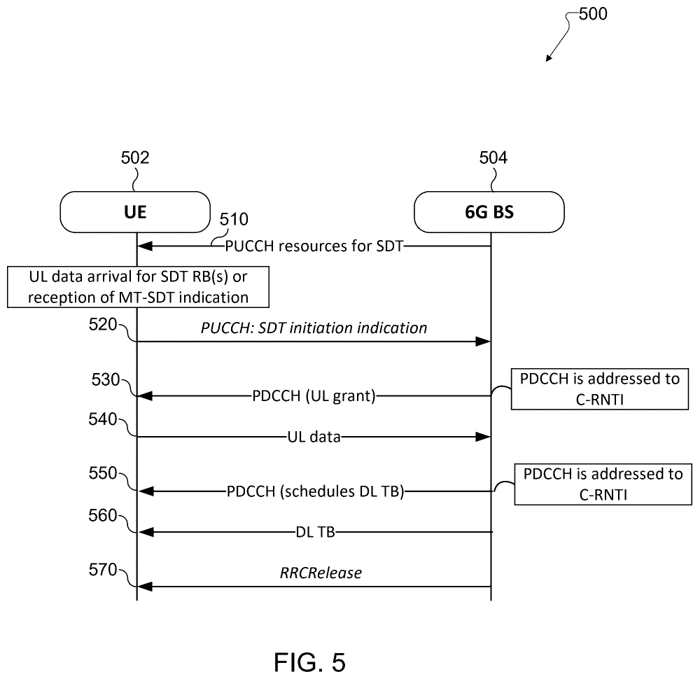

FIGS. 6A-6B illustrate another example procedure 600 for small data transmission in a cell according to embodiments of the present disclosure. An embodiment of the procedure illustrated in FIGS. 6A-6B is for illustration only. One or more of the components illustrated in FIGS. 6A-6B may be implemented in specialized circuitry configured to perform the noted functions or one or more of the components may be implemented by one or more processors executing instructions to perform the noted functions. Other embodiments of a procedure for small data transmission in a cell could be used without departing from the scope of this disclosure.

In the example of FIGS. 6A-6B, procedure 600 begins at operation 610. At operation 610, a UE 602 (which may be similar or identical to UE 116 of FIG. 1) receives a configuration of PUCCH resources for small data transmission from the network 604 (e.g., from a base station of the cell, gNB of the cell etc.).

In some embodiments, the configuration of PUCCH resources for small data transmission can be received in an RRCRelease message (or an RRCRelease message with suspend config). In some embodiments, the configuration of PUCCH resources for small data transmission can be received in an RRC message.

In some embodiments, the configuration of PUCCH resources for small data transmission can be received for an NUL carrier and/or the configuration of PUCCH resources for small data transmission can be received for an SUL carrier. In these embodiments, the configuration of PUCCH resources for small data transmission can be separately received for the NUL and the SUL carriers.

In some embodiments, the configuration of PUCCH resources for small data transmission can indicate PUCCH occasions/resources, a periodicity at which PUCCH an occasion/resource occurs in the time domain, frequency domain (PRBs/REs) resource information of a PUCCH occasion/resource, subcarrier spacing associated with PUCCH resources, a list of one or more SSBs/CSI-RSs associated with configuration of PUCCH resources for small data transmission, the number of SSBs/CSI-RSs per PUCCH occasion, a threshold for SSB/CSI-RS selection, etc. PUCCH occasions signaled by the configuration can be mapped to SSBs/CSI-RSs associated with the configuration. For example, if the number of SSBs/CSI-RSs per PUCCH occasion is 2 and SSB1/CSI-RS1 to SSB8/CSI-RS8 are associated with the configuration of PUCCH resources for small data transmission, SSB1/CSI-RS1 and SSB2/CSI-RS2 are associated with a first PUCCH occasion, SSB3/CSI-RS3 and SSB4/CSI-RS4 are associated with a second PUCCH occasion, SSB5/CSI-RS5 and SSB6/CSI-RS6 are associated with third PUCCH occasion, SSB7/CSI-RS7 and SSB8/CSI-RS8 are associated with a fourth PUCCH occasion, etc. In another example, if the number of SSBs/CSI-RSs per PUCCH occasion is 1 and SSB1/CSI-RS1 to SSB 8/CSI-RS8 are associated with the configuration of PUCCH resources for small data transmission, SSB1/CSI-RS1 is associated with a first PUCCH occasion, SSB2/CSI-RS2 is associated with second PUCCH occasion, SSB3/CSI-RS3 is associated with a third PUCCH occasion, SSB4/CSI-RS4 is associated with fourth a PUCCH occasion, etc.

In some embodiments, a PUCCH resource can be small enough to carry 1 bit information (e.g., an SDT indication) or indicate an SDT indication.

At operation 610, UE 602 also receives a configuration of CG resources for small data transmission from network 604 (e.g., a base station of cell, gNB of cell etc.).

In some embodiments, the configuration of CG resources for small data transmission can be received in an RRCRelease message (or an RRCRelease message with suspend config). In some embodiments the configuration of CG resources for small data transmission can be received in an RRC message.

In some embodiments, the configuration of CG resources for small data transmission can be received for an NUL carrier and/or the configuration of CG resources for small data transmission can be received for an SUL carrier. In these embodiments, the configuration of CG resources for small data transmission can be separately received for the NUL and the SUL carriers.

In some embodiments, the configuration of CG resources for small data transmission can indicate CG occasions/resources, a periodicity at which a CG occasion/resource occurs in the time domain, frequency domain (PRBs/REs) resource info of a CG occasion/resource, subcarrier spacing associated with CG resources, a list of one or more SSBs/CSI-RSs associated with configuration of CG resources for small data transmission, a number of SSBs per CG occasion, a threshold for SSB/CSI-RS selection, etc. CG occasions signaled by the configuration can be mapped to SSBs/CSI-RSs associated with the configuration. For example, if the number of SSBs/CSI-RSs per CG occasion is 2 and SSB1/CSI-RS1 to SSB8/CSI-RS8 are associated with the configuration of CG resources for small data transmission, SSB1/CSI-RS1 and SSB2/CSI-RS2 are associated with a first CG occasion, SSB3/CSI-RS3 and SSB4/CSI-RS4 are associated with a second CG occasion, SSB5/CSI-RS5 and SSB6/CSI-RS6 are associated with a third CG occasion, SSB7/CSI-RS7 and SSB8/CSI-RS8 are associated with a fourth CG occasion, etc. In another example, if the number of SSBs/CSI-RSs per CG occasion is 1 and SSB1/CSI-RS1 to SSB 8/CSI-RS8 are associated with the configuration of CG resources for small data transmission, SSB1/CSI-RS1 is associated with first CG occasion, SSB2/CSI-RS2 is associated with a second CG occasion, SSB3/CSI-RS3 is associated with a third CG occasion, SSB4/CSI-RS4 is associated with a fourth CG occasion, etc.

In some embodiments, a CG resource can be large enough to carry UL data.

At operation 620, UE 602 initiates the CG based small data transmission.

In some embodiments, for MO-SDT (i.e., UL data arrives for one or more RBs configured for SDT):
If data volume of the pending UL data across all RBs configured for SDT is less than or equal to sdt-DataVolume Threshold; and
if the RSRP of the downlink pathloss reference is higher than sdt-RSRP-Threshold or if sdt-RSRP-Threshold is not configured:
   If the Serving Cell (i.e., the cell where UE 602 is currently camped) is configured with a supplementary uplink and if the RSRP of the downlink pathloss reference is less than rsrp-ThresholdSSB-SUL, UE 602 selects the SUL carrier. Otherwise, UE 602 selects the NUL carrier.
   If CG resources for small data transmission are configured for the selected UL carrier and UE 602 has valid TA in the first available CG occasion for initial transmission on CG, and if at least one SSB/CSI-RS configured for CG resources for small data transmission with SS-RSRP/CSIRS-RSRP above a threshold (the threshold can be configured by network 604) is available, UE 602 initiates CG based small data transmission.
   Note that if CG resources for small data transmission are received from Cell “A” and UE 602's current camped cell is not Cell A, CG resources for small data transmission are not considered configured in the currently camped cell.

In some embodiments, for MT-SDT (i.e., and MT-SDT indication is received from network), if the RSRP of the downlink pathloss reference is higher than sdt-RSRP-Threshold or if sdt-RSRP-Threshold is not configured:
if the Serving Cell (i.e., the cell where UE 602 is currently camped) is configured with a supplementary uplink and if the RSRP of the downlink pathloss reference is less than rsrp-ThresholdSSB-SUL, UE 602 selects the SUL carrier. Otherwise, UE 602 selects the NUL carrier.
If CG resources for small data transmission are configured for the selected UL carrier and UE 602 has valid TA in the first available CG occasion for initial transmission on the CG, and if at least one SSB/CSI-RS configured for CG resources for small data transmission with SS-RSRP/CSIRS-RSRP above a threshold (the threshold can be configured by network) is available, UE 602 initiates CG based small data transmission.
Note that if CG resources for small data transmission are received from a Cell “A” and UE 602's current camped cell is not Cell A, CG resources for small data transmission are not considered configured in the currently camped cell.

In some embodiments, upon the reception of CG resources for small data transmission, UE 602 stores the current RSRP of the downlink pathloss reference for TA validation. TA for initial transmission on the CG for small data transmission is valid when the following conditions are fulfilled:
The RSRP values for the stored downlink pathloss reference and the current downlink pathloss reference are valid; and
compared to the stored downlink pathloss reference RSRP value, the current RSRP value of the downlink pathloss reference has not increased/decreased by more than cg-SDT-RSRP-Change Threshold, if configured; and
cg-SDT-TimeAlignmentTimer is running (UE 602 may start the cg-SDT-TimeAlignmentTimer when PUCCH resources for small data transmission are received).

UE 602 selects a PUCCH occasion. In some embodiments, UE 602 selects the (first available) PUCCH occasion associated with an SSB/CSI-RS with SS-RSRP/CSIRS-RSRP above a threshold. UE 602 transmits an SDT indication in the selected PUCCH occasion.

UE 602 then selects a CG occasion. In some embodiments UE 602 selects the (first available, or first available after an offset from the PUCCH occasion in which the SDT indication is sent, the offset can be configured/signaled by network 604 [e.g., in an RRC message or SI]) CG occasion associated with an SSB/CSI-RS with an SS-RSRP/CSIRS-RSRP above a threshold. UE 602 transmits UL data and/or a BSR in the selected CG occasion. UE 602 may transmit an RRCResumeRequest/RRCSetupRequest in the CG occasion. In some embodiments, after transmitting the SDT indication in the PUCCH occasion, UE 602 waits for a PDCCH addressed to C-RNTI from network 604 for a pre-defined/configured time/window. Upon receiving a PDCCH addressed to the C-RNTI from network 604, UE 602 may use/select a CG occasion for UL transmission. In some embodiments, after transmitting the SDT indication in the PUCCH occasion, if the UE does not receive a PDCCH addressed to a C-RNTI (or if the UE does not receive a PDCCH addressed to a C-RNTI within a pre-defined/configured time or window), the UE may select the PUCCH occasion in similar manner as the earlier PUCCH occasion selection and transmit the SDT indication.

Upon receiving the SDT indication in the PUCCH occasion, network 604 (e.g., a base station of the cell, gNB of the cell etc.) identifies the UE 602, as the PUCCH occasion/resource in which the SDT indication is received was assigned to the UE 602. Network 604 does not use the CG resources configured to UE 602 for other purposes (e.g., assigning the CG resources to other UEs) until the SDT procedure is terminated (e.g., the SDT timer is expired or an RRCRelease is sent by network 604 or an SDT termination indication is received in a PUCCH occasion/CG occasion/UL grant). The CG resources configured for SDT can be repurposed by the network after the SDT procedure is terminated and until the SDT initiation indication is received by the network. The CG resources configured for SDT can be repurposed by the network after the RRCRelease or RRC message including the CG resource configuration for SDT and until the SDT initiation indication is received by the network. Network 604 (e.g., a base station of the cell, gNB the of cell etc.) may transmit one or more PDCCHs addressed to a C-RNTI (the C-RNTI of the identified UE 602) during the SDT procedure.

A PDCCH addressed to C-RNTI may schedule a UL grant to UE 602. At operation 630, UE 602 transmits UL data (from SDT RB[s] and/or a BSR) in the received UL grant.

A PDCCH addressed to the C-RNTI may schedule a DL TB to UE 602. At operation 640, UE 602 receives DL data (from SDT RB[s]) in the received DL TB. The UL data can be integrity protected.

For UL transmission in a CG occasion, retransmission can be performed using a CG occasion or the retransmission can be performed using a scheduled UL grant.

At operation 650, network 604 (e.g., a base station of the cell, gNB of the cell etc.) sends an RRCRelease message to terminate the SDT procedure. UE 602 terminates the SDT procedure. In some embodiments, if the SDT procedure is terminated by UE 602, UE 602 may send an SDT termination indication in a PUCCH occasion or using an UL grant/CG occasion.

Although FIGS. 6A-6B illustrate one example procedure 600 for small data transmission in a cell, various changes may be made to FIGS. 6A and/or 6B. For example, while shown as a series of operations, various operations in FIGS. 6A and 6B could overlap, occur in parallel, occur in a different order, occur any number of times, be omitted, or replaced by other operations.

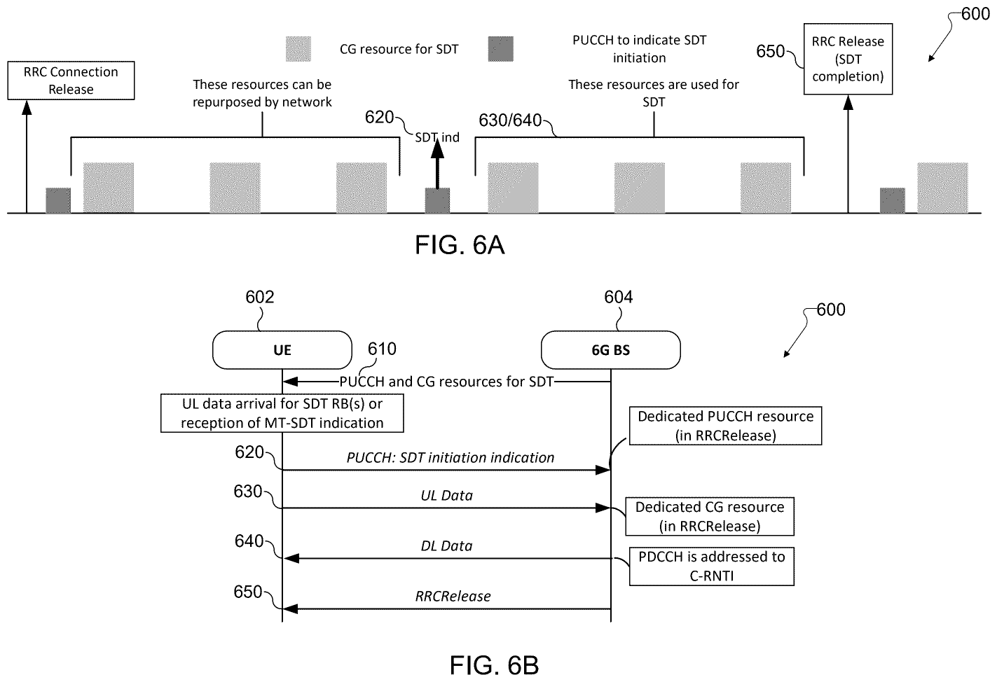

FIG. 7 illustrates an example procedure 700 for a resource reconfiguration for configured grant based small data transmission according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for a resource reconfiguration for configured grant based small data transmission could be used without departing from the scope of this disclosure.

In the example of FIG. 7, procedure 700 begins at operation 710. At operation 710, a UE 702 (which may be similar or identical to UE 116 of FIG. 1) receives a configuration of CG-SDT including CG-SDT resources in a first cell 704 (e.g., the first cell 704 can be a 5G or New Radio (NR) cell or a 6G or 6G Radio (6GR) cell or a cell of any radio access technology [RAT]). The configuration is received in an RRC message (e.g., an RRCRelease message).

At operation 715, upon receiving the configuration, UE 702 stores the current timing advance value for the first cell and starts cg-SDT-TimeAlignmentTimer.

At operation 720, in the first cell 704, UE 702 uses the CG-SDT resources configured by the received configuration for small data transmission if the TA is valid.

At operation 725, UE 702 is in RRC_IDLE/RRC_INACTIVE state. UE 702 performs cell (re) selection to a second cell 706 (e.g., second cell 706 can be a 5G or NR cell or a 6G or 6GR cell or cell of any RAT). UE 702 releases (or stops using) the configuration of CG-SDT incuding CG-SDT resources received from the first cell.

At operation 730, if the second cell 706 supports CG-SDT (whether the second cell 706 supports CG-SDT can be signaled in the system information transmitted by the second cell 706) or second cell 706 supports CG-SDT resource request (whether the second cell supports CG-SDT can be signaled in the system information transmitted by the second cell), UE 702 initiates a CG-SDT resource request procedure (or initiates a random access procedure).

In some embodiments, during the CG-SDT resource request procedure (or random access procedure), UE 702 transmits a RACH preamble to second cell (e.g., operation 735). The UE receives a RAR in response to transmitted RACH preamble from second cell 706 (e.g., operation 740. RAR includes TA, UL grant and TC-RNTI. The UE transmits an CG-SDT resource request to the second cell 706 in the UL grant received in the RAR (e.g., operation 745). In some embodiments, the CG-SDT resource request can be an RRC message or a MAC CE or an indication in a MAC CE. In some embodiments the CG-SDT resource request can be an RRC resume request message including an indication for a CG-SDT resource request. In some embodiments, a resume cause indicating CG-SDT resource request can be included in an RRC resume request message. In some embodiments, the CG-SDT resource request can include a UE identity (e.g., I-RNTI, S-TMSI, etc.) In some embodiments the CG-SDT resource request may include MAC-I (e.g., resumeMAC-I). UE 702 receives an CG-SDT resource response including CG-SDT resources in response to the request (e.g., operation 755. In an embodiment, CG-SDT resource request can be an RRC message (e.g., RRCRelease message). UE 702 stores the C-RNTI received in RAR and uses it for receiving the PDCCH during CG-SDT procedure in the second cell.

Alternately, in some embodiments, during the CG-SDT resource request procedure (or random access procedure), UE 702 transmits a MsgA (i.e., a PRACH preamble and MsgA MAC PDU) to second cell 706 (e.g., operation 735). UE 702 transmits a CG-SDT resource request to the second cell in the MsgA MAC PDU. In some embodiments, the CG-SDT resource request can be a RRC message or MAC CE or an indication in a MAC CE. In some embodiments, the CG-SDT resource request can be an RRC resume request message including an indication for CG-SDT resource request. In some embodiments, the resume cause indicating CG-SDT resource request can be included in an RRC resume request message. UE 702 receives a MsgB in response to transmitted MsgA from second cell 706 (e.g., at operation 750). The MsgB includes TA and C-RNTI. The MsgB may include a CG-SDT resource response including CG-SDT resources in response to the request. In some embodiments, the CG-SDT resource request can be an RRC message (e.g., and RRCRelease message). In some embodiments, the CG-SDT resource response can be received after the MsgB. UE 702 stores the C-RNTI received in MsgB and uses it for receiving the PDCCH during CG-SDT procedure in the second cell 706.

At operation 755, UE 702 stores the current timing advance value for the second cell 706 and restarts cg-SDT-TimeAlignmentTimer. In the second cell 706, UE 702 uses the CG-SDT resources configured by the received configuration for small data transmission from the second cell 706 if the TA is valid.

In some embodiments, upon the reception of CG resources for small data transmission, UE 702 stores the current RSRP of the downlink pathloss reference for TA validation. TA for initial transmission on CG for small data transmission is valid when the following conditions are fulfilled:
The RSRP values for the stored downlink pathloss reference and the current downlink pathloss reference are valid; and
compared to the stored downlink pathloss reference RSRP value, the current RSRP value of the downlink pathloss reference has not increased/decreased by more than cg-SDT-RSRP-Change Threshold, if configured; and
cg-SDT-TimeAlignmentTimer is running (UE may start the cg-SDT-TimeAlignmentTimer when CG resources for small data transmission is received).

In some embodiments, CG-SDT resources in procedure 700 of FIG. 7 can be PUCCH resources for small data transmission and UE 702 can use the procedure 700 for requesting PUCCH resources for small data transmission.

Although FIG. 7 illustrates one example procedure 700 for a resource reconfiguration for configured grant based small data transmission, various changes may be made to FIG. 7. For example, while shown as a series of operations, various operations in FIG. 7 could overlap, occur in parallel, occur in a different order, occur any number of times, be omitted, or replaced by other operations.

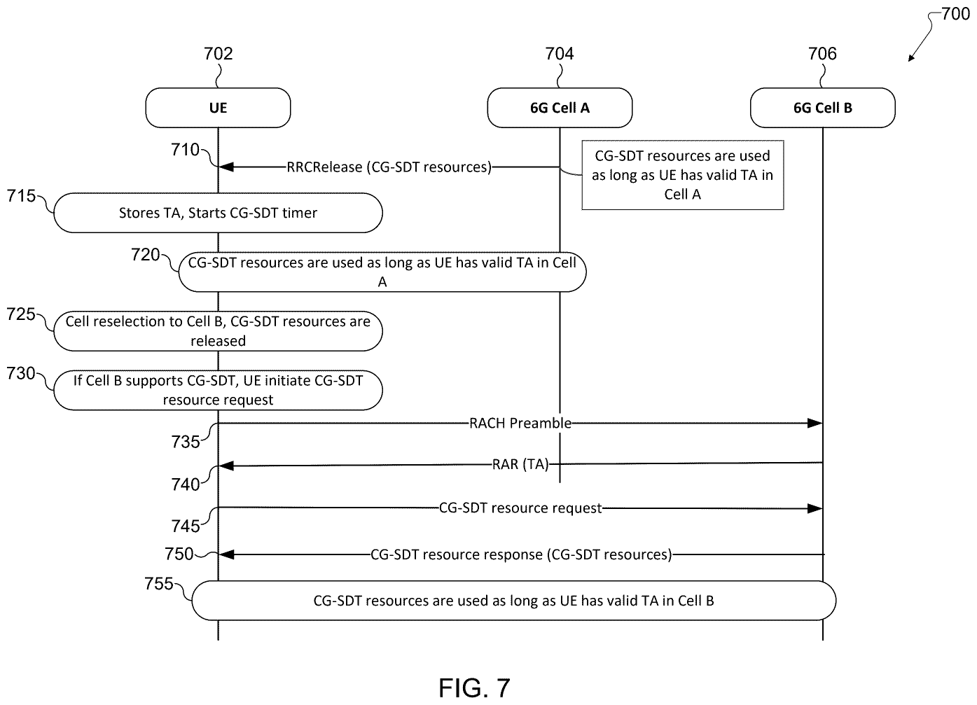

FIG. 8 illustrates an example procedure 800 for a TA reacquisition for small data transmission in a cell according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for a TA reacquisition for small data transmission in a cell could be used without departing from the scope of this disclosure.

In the example of FIG. 8, procedure 800 begins at operation 810. At operation 810, a UE 802 (which may be similar or identical to UE 116 of FIG. 1) receives a configuration of CG-SDT incuding CG-SDT resources in a cell 804 (e.g., cell 804 can be a 5G or NR cell or a 6G or 6GR cell or a cell of any RAT). The configuration is received in an RRC message (e.g., an RRCRelease message).

At operation 815, upon receiving the configuration, UE 802 stores the current timing advance value for the first cell and starts cg-SDT-TimeAlignmentTimer.

At operation 820, UE 802 is in RRC_IDLE/RRC_INACTIVE state. In the cell 804, UE 802 uses the CG-SDT resources configured by the received configuration for small data transmission if the TA is valid.

At operation 825, if the TA becomes invalid in the cell 804 and cell 804 supports TA reacquisition of CG-SDT or small data transmission (whether the cell 804 supports TA reacquisition of CG-SDT or small data transmission can be signaled in the system information transmitted by the cell 804), UE 802 initiates a TA reacquisition procedure (or initiates a random access procedure). Upon the reception of CG resources for small data transmission, UE 702 stores the current RSRP of the downlink pathloss reference for TA validation. TA is considered invalid if cg-SDT-TimeAlignmentTimer expires. TA is also considered invalid if compared to the stored downlink pathloss reference RSRP value, the current RSRP value of the downlink pathloss reference has increased/decreased by more than cg-SDT-RSRP-Change Threshold, if configured.

In some embodiments, during the TA reacquisition procedure (or random access procedure), UE 802 transmits a RACH preamble to cell 804 (e.g., at operation 830). UE 802 receives a RAR in response to the transmitted RACH preamble from cell 804 (e.g., at operation 835). The RAR includes a TA, UL grant and TC-RNTI. UE 840 transmits a TA reacquisition request to the cell 804 in the UL grant received in the RAR or transmits a C-RNTI MAC CE including the C-RNTI in the UL grant received in RAR (e.g., at operation 840). In some embodiments, the TA reacquisition request can be an RRC message or MAC CE or an indication in a MAC CE. In some embodiments, the TA reacquisition request can be an RRC resume request message including an indication for a TA reacquisition request and a UE identity such as I-RNTI or S-TMSI. In some embodiments, a resume cause indicating TA reacquisition request can be included in the RRC resume request message. UE 802 receives contention resolution MAC CE or PDCCH addressed to a C-RNTI in response (e.g., at operation 845). In some embodiments, if the contention resolution MAC CE includes the (first 48bits of) CCCH SDU (TA reacquisition request) transmitted, the contention resolution is successful, and the random access procedure is completed successfully. In some embodiments, if a PDCCH addressed to the C-RNTI is received, the random access procedure is completed successfully.

Alternately, in some embodiments, during the TA reacquisition procedure (or random access procedure), UE 802 transmits a MsgA (i.e., PRACH preamble and MsgA MAC PDU) to cell 804 (e.g., at operation 830). UE 802 transmits a TA reacquisition request to the cell 804 in the MsgA MAC PDU. In some embodiments, the TA reacquisition request can be an RRC message or a MAC CE or an indication in a MAC CE. In some embodiments, the TA reacquisition request can be an RRC resume request message including an indication for a TA reacquisition request. In some embodiments, a resume cause indicating a TA reacquisition request can be included in the RRC resume request message. In some embodiments, UE 802 receives a MsgB in response to the transmitted MsgA from cell 804 (e.g., at operation 845). The MsgB includes a TA and contention resolution MAC CE. If the contention resolution MAC CE includes the (first 48bits of) CCCH SDU (TA reacquisition request) transmitted, the contention resolution is successful, and the random access procedure is completed successfully. In some embodiments, the random access procedure is completed if UE 802 receives a PDCCH addressed to a C-RNTI scheduling a DL TB which includes an absolute timing command MAC CE which includes a TA.

At operation 850, UE 802 stores the timing advance value received during the random access procedure and restarts cg-SDT-Time AlignmentTimer.

Although FIG. 8 illustrates one example procedure 800 for a TA reacquisition for small data transmission in a cell, various changes may be made to FIG. 8. For example, while shown as a series of operations, various operations in FIG. 8 could overlap, occur in parallel, occur in a different order, occur any number of times, be omitted, or replaced by other operations.

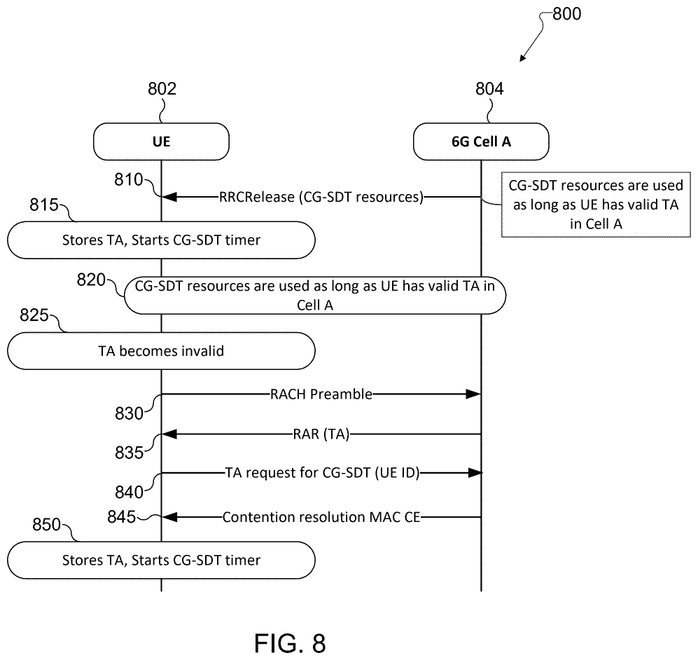

FIG. 9 illustrates an example procedure 900 to transmit and receive paging according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of to transmit and receive paging could be used without departing from the scope of this disclosure.

In the example of FIG. 9, procedure 900 begins at operation 910. At operation 910, a UE 902 (which may be similar or identical to UE 116 of FIG. 1) may receive a first UE specific DRX cycle value for paging (T1) from a core network 906 (e.g., from access and mobility management function [AMF]). A non-access stratum (NAS) signaling message may be used to receive the first UE specific DRX cycle value for paging.

At operation 915, UE 902 may receive a second UE specific DRX cycle value for paging (T2) from a gNB 904. An RRC signaling message may be used to receive the second UE specific DRX cycle value for paging. The second UE specific DRX cycle value for paging may also be referred to as ran-PagingCycle and received in an RRCRelease message from the gNB 904.

At operation 920, UE 902 may receive a default DRX cycle value for paging (T3) from system information transmitted by the camped cell. The default DRX cycle value for paging can also be referred to as defaultPagingCycle and received in the SIB (e.g., SIB1) of the camped cell in an RRC_IDLE/RRC_INACTIVE state or of the PCell in an RRC_CONNECTED state.

At operation 920, UE 902 may also receive a first paging configuration from the camped cell while in an RRC_IDLE/RRC_INACTIVE state or from the PCell in an RRC_CONNECTED state.

In some embodiments, the first paging configuration may include a first value of N (number of paging frames in DRX cycle T), first value of Ns (number of paging occasions per paging frame) and the first value of a paging frame offset. N, Ns and the paging frame offset of the first paging configuration can be received in the SIB (e.g., SIB1).

In some embodiments, the first paging configuration may include a first value of pagingSearchSpace.

In some embodiments, the first paging configuration may include firstPDCCH-MonitoringOccasionOfPO (firstPDCCH-MonitoringOccasionOfPO points out the first PDCCH monitoring occasion for paging of each PO of the PF).

In some embodiments, the first paging configuration may include firstPDCCH-MonitoringOccasionOfPEI-O (firstPDCCH-MonitoringOccasionOfPEI-O indicates the first PDCCH monitoring occasion of each PEI-O of the PF).

In some embodiment,s firstPDCCH-MonitoringOccasionOfPO, firstPDCCH-MonitoringOccasionOfPEI-O, and pagingSearchSpace of the first paging configuration can be per BWP and received in a BWP configuration of a BWP in which UE 902 receives paging. In these embodiments, firstPDCCH-MonitoringOccasionOfPO, firstPDCCH-MonitoringOccasionOfPEI-O, pagingSearchSpace of the first paging configuration for the intial BWP configuration is received in SIB (e.g., SIB1). firstPDCCH-MonitoringOccasionOfPO, firstPDCCH-MonitoringOccasionOfPEI-O, pagingSearchSpace of the first paging configuration for the BWP other than the intial BWP configuration is received in dedicated RRC signaling. In an RRC_IDLE/RRC_INACTIVE state, UE 902 receives paging in an initial downlink BWP. In an RRC_CONNECTED state, UE 902 receives paging in an active DL BWP, wherein the active DL BWP is the one of several BWPs configured to UE 902. The active DL BWP can be an initial downlink BWP.

At operation 920, UE 902 may also receive a second paging configuration from the camped cell in an RRC_IDLE/RRC_INACTIVE state or from the PCell in an RRC_CONNECTED state. The second paging configuration is for paging based on paging adaptation/clustering/bundling.

In some embodiments, the second paging configuration may include a second value of N (number of paging frames in DRX cycle T), second value of Ns (number of paging occasions per paging frame), and second value of a paging frame offset. N, Ns and the paging frame offset of the second paging configuration can be received in the SIB (e.g., SIB1).

In some embodiments, the second paging configuration may include firstPDCCH-MonitoringOccasionOfPO (firstPDCCH-MonitoringOccasionOfPO points out the first PDCCH monitoring occasion for paging of each PO of the PF).

In some embodiments, the second paging configuration may include firstPDCCH-MonitoringOccasionOfPEI-O (firstPDCCH-MonitoringOccasionOfPEI-O indicates the first PDCCH monitoring occasion of each PEI-O of the PF).

In some embodiments, the second paging configuration may include a second value of pagingSearchSpace.

In some embodiments, firstPDCCH-MonitoringOccasionOfPO, firstPDCCH-MonitoringOccasionOfPEI-O, pagingSearchSpace of the second paging configuration can be per BWP and received in a BWP configuration of a BWP in which UE 902 receives paging. In these embodiments, firstPDCCH-MonitoringOccasionOfPO, firstPDCCH-MonitoringOccasionOfPEI-O, and pagingSearchSpace of the second paging configuration for the intial BWP configuration is received in a SIB (e.g., SIB1). firstPDCCH-MonitoringOccasionOfPO, firstPDCCH-MonitoringOccasionOfPEI-O, and pagingSearchSpace of the second paging configuration for the BWP other than the initial BWP configuration is received in dedicated RRC signaling. In an RRC_IDLE/RRC_INACTIVE state, UE 902 receives paging in an initial downlink BWP. In an RRC_CONNECTED state, UE 902 receives paging in active DL BWP wherein active DL BWP is the one of several BWPs configured to UE. active DL BWP can be initial downlink BWP.

At operation 925, UE 902 determines if the minimum of the first UE specific DRX cycle value for paging (T1) and the second UE specific DRX cycle value for paging (T2) is smaller than the default DRX cycle value for paging (T3) (or smaller than DRX cycle value for paging adaptation/clustering/bundling). Operation 925 may be performed if UE 902 is in an RRC_INACTIVE state, as T2 is applicable in the RRC_INACTIVE state. If the minimum of the first UE specific DRX cycle value for paging (T1) and the second UE specific DRX cycle value for paging (T3) is smaller than the default DRX cycle value for paging (T3) (or smaller than DRX cycle value for paging adaptation/clustering/bundling), procedure 900 proceeds to operation 930. Otherwise, if the minimum of the first UE specific DRX cycle value for paging (T1) and the second UE specific DRX cycle value for paging (T3) is not smaller than the default DRX cycle value for paging (T3) (or not smaller than DRX cycle value for paging adaptation/clustering/bundling), procedure 900 proceeds to operation 935.

At operation 930, UE 902 does not apply the paging adaptation/clustering/bundling configuration. UE 902 monitors paging based on the first paging configuration. UE 902 determines its PF/PO for paging based on at least one of the first value of N, first value of Ns, first value of the paging frame offset (PF_offset) and the first value of firstPDCCH-MonitoringOccasionOfPO in the first paging configuration. UE 902 determines the PDCCH monitoring occasions for paging based on first value of pagingSearchSpace.

$$T = min ( T 1 , T 2 and T 3 )$$

System frame number (SFN) for the PF is determined by:

$$( SFN + PF\_offset ) mod T = {( T divN )}^{*} ( UE\_IDmod N )$$

Index (i_s), indicating the index of the PO is determined by:

$$i\_s = floor ( UE\_ID / N ) mod Ns$$

UE 902 monitors paging (i.e., a PDCCH addressed to P-RNTI) in the determined PO indicated by i_s. UE 902 may monitor a PEI before a PO where PEI-O is determined based on firstPDCCH-MonitoringOccasionOfPEI-O in the first paging configuration.

At operation 935, UE 902 applies the paging adaptation/clustering/bundling configuration to determine a PF/PO. UE 902 determines a PF/PO amongst the clustered/bundled PF/PO. UE 902 monitors paging based on the second paging configuration. UE 902 determines its PF/PO for paging based on at least one of the second value of N and second value of Ns in the second paging configuration. If the second value of the paging frame offset is configured in the second paging configuration, UE 902 applies the second value of the paging frame offset to determine PF. Otherwise UE 902 applies the first value of paging frame offset to determine PF. If the firstPDCCH-MonitoringOccasionOfPO is configured in the second paging configuration, UE 902 applies it to determine a PO. Otherwise, UE 902 applies the firstPDCCH-MonitoringOccasionOfPO (if configured) in first paging configuration to determine a PO. In an alternate embodiment, If the firstPDCCH-MonitoringOccasionOfPO is not configured in the second paging configuration, UE 902 does not apply firstPDCCH-MonitoringOccasionOfPO to determine a PO. When firstPDCCH-MonitoringOccasionOfPO is applied to determine a PO, the starting PDCCH monitoring occasion number of (i_s+1)^{th}PO is the (i_s+1)^{th}value of the firstPDCCH-MonitoringOccasionOfPO parameter. Otherwise, it is equal to i_s*S*X. As explained earlier, a PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. If the second value of pagingSearchSpace is configured in the second paging configuration, UE 902 applies the second value of pagingSearchSpace to determine the PDCCH monitoring occasions for paging. Otherwise, UE 902 applies the first value of pagingSearchSpace to determine the PDCCH monitoring occasions for paging.

$$T = min ( T 1 , T 2 and T 3 ) or T 3 or max ( T 1 , T 2 , T 3 )$$

System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

UE 902 monitors paging (i.e., a PDCCH addressed to a P-RNTI) in the determined PO indicated by i_s. UE 902 may monitor a PEI before a PO where PEI-O is determined based on firstPDCCH-MonitoringOccasionOfPEI-O (if configured) in the second paging configuration.

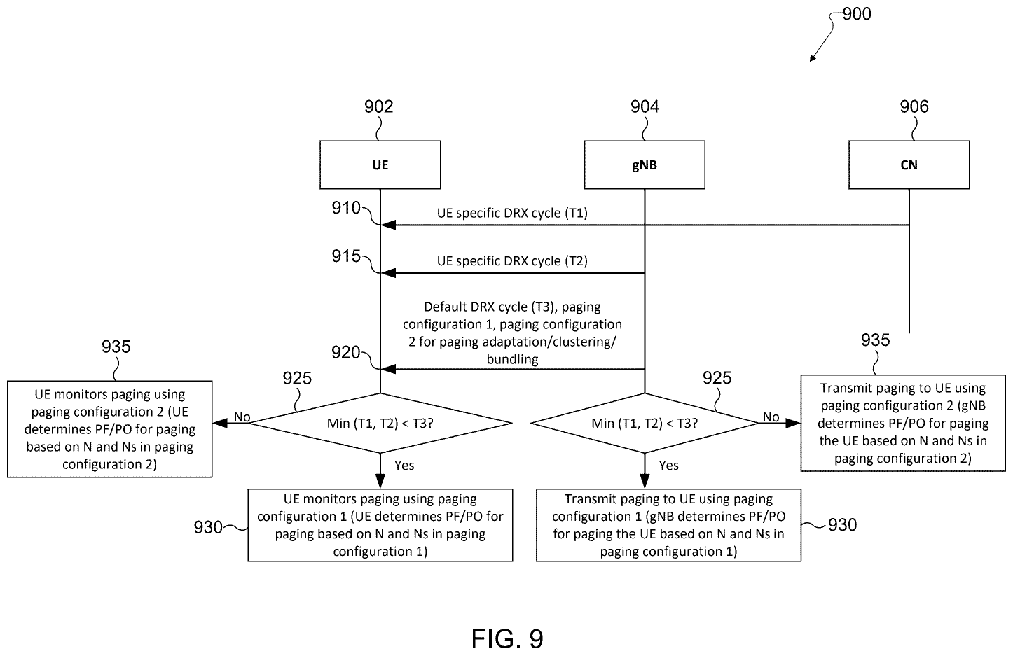

FIG. 10 illustrates another example procedure 1000 to transmit and receive paging according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of to transmit and receive paging could be used without departing from the scope of this disclosure.

In the example of FIG. 10, procedure 1000 begins at operation 1010. At operation 1010, a UE 1002 (which may be similar or identical to UE 116 of FIG. 1) may receive a UE specific DRX cycle value for paging (T1) from a core network 1006 (e.g., from access and mobility management function [AMF]). A non-access stratum (NAS) signaling message may be used to receive the UE specific DRX cycle value for paging.

At operation 1020, UE 1002 may receive a default DRX cycle value for paging (T3) from system information transmitted by the camped cell (e.g., from gNB 1004). The default DRX cycle value for paging can also be referred to as defaultPagingCycle and received in the SIB (e.g., SIB1) of the camped cell in an RRC_IDLE/RRC_INACTIVE state or of the PCell in an RRC_CONNECTED state.

At operation 1020, UE 1002 may also receive a first paging configuration from the camped cell while in an RRC_IDLE/RRC_INACTIVE state or from the PCell in an RRC_CONNECTED state.

In some embodiments, the first paging configuration may include a first value of N (number of paging frames in DRX cycle T), first value of Ns (number of paging occasions per paging frame) and the first value of a paging frame offset. N, Ns and the paging frame offset of the first paging configuration can be received in the SIB (e.g., SIB1).

In some embodiments, the first paging configuration may include a first value of pagingSearchSpace.

In some embodiments, the first paging configuration may include firstPDCCH-MonitoringOccasionOfPO (firstPDCCH-MonitoringOccasionOfPO points out the first PDCCH monitoring occasion for paging of each PO of the PF).

In some embodiments, the first paging configuration may include firstPDCCH-MonitoringOccasionOfPEI-O (firstPDCCH-MonitoringOccasionOfPEI-O indicates the first PDCCH monitoring occasion of each PO of the PF).

In some embodiment,s firstPDCCH-MonitoringOccasionOfPO, firstPDCCH-MonitoringOccasionOfPEI-O, and pagingSearchSpace of the first paging configuration can be per BWP and received in a BWP configuration of a BWP in which UE 1002 receives paging. In these embodiments, firstPDCCH-MonitoringOccasionOfPO, firstPDCCH-MonitoringOccasionOfPEI-O, pagingSearchSpace of the first paging configuration for the intial BWP configuration is received in SIB (e.g., SIB1). firstPDCCH-MonitoringOccasionOfPO, firstPDCCH-MonitoringOccasionOfPEI-O, pagingSearchSpace of the first paging configuration for the BWP other than the intial BWP configuration is received in dedicated RRC signaling. In an RRC_IDLE/RRC_INACTIVE state, UE 1002 receives paging in an initial downlink BWP. In an RRC_CONNECTED state, UE 1002 receives paging in an active DL BWP, wherein the active DL BWP is the one of several BWPs configured to UE 1002. The active DL BWP can be an initial downlink BWP.

At operation 1020, UE 1002 may also receive a second paging configuration from the camped cell in an RRC_IDLE/RRC_INACTIVE state or from the PCell in an RRC_CONNECTED state. The second paging configuration is for paging based on paging adaptation/clustering/bundling.

In some embodiments, the second paging configuration may include a second value of N (number of paging frames in DRX cycle T), second value of Ns (number of paging occasions per paging frame), and second value of a paging frame offset. N, Ns and the paging frame offset of the second paging configuration can be received in the SIB (e.g., SIB1).

In some embodiments, the second paging configuration may include firstPDCCH-MonitoringOccasionOfPO (firstPDCCH-MonitoringOccasionOfPO points out the first PDCCH monitoring occasion for paging of each PO of the PF).

In some embodiments, the second paging configuration may include firstPDCCH-MonitoringOccasionOfPEI-O (firstPDCCH-MonitoringOccasionOfPEI-O indicates the first PDCCH monitoring occasion of each PO of the PF).

In some embodiments, the second paging configuration may include a second value of pagingSearchSpace.

In some embodiments, firstPDCCH-MonitoringOccasionOfPO, firstPDCCH-MonitoringOccasionOfPEI-O, pagingSearchSpace of the second paging configuration can be per BWP and received in a BWP configuration of a BWP in which UE 1002 receives paging. In these embodiments, firstPDCCH-MonitoringOccasionOfPO, firstPDCCH-MonitoringOccasionOfPEI-O, and pagingSearchSpace of the second paging configuration for the intial BWP configuration is received in a SIB (e.g., SIB1). firstPDCCH-MonitoringOccasionOfPO, firstPDCCH-MonitoringOccasionOfPEI-O, and pagingSearchSpace of the second paging configuration for the BWP other than the initial BWP configuration is received in dedicated RRC signaling. In an RRC_IDLE/RRC_INACTIVE state, UE 1002 receives paging in an initial downlink BWP. In an RRC_CONNECTED state, UE 1002 receives paging in active DL BWP wherein active DL BWP is the one of several BWPs configured to UE. active DL BWP can be initial downlink BWP.

At operation 1025, UE 1002 determines if the UE specific DRX cycle value for paging (T1) is smaller than the default DRX cycle value for paging (T3) (or smaller than DRX cycle value for paging adaptation/clustering/bundling). This operation may be performed if UE 1002 is in an RRC_IDLE state. This operation may be performed in an RRC_INACTIVE state if a UE specific DRX cycle value T2 is not received from gNB 1004 (e.g., similar as described regarding operation 925 of procedure 900). If the UE specific DRX cycle value for paging (T1) is smaller than the default DRX cycle value for paging (T3) (or smaller than DRX cycle value for paging adaptation/clustering/bundling), procedure 1000 proceeds to operation 1030. Otherwise, if the UE specific DRX cycle value for paging (T1) is not smaller than default DRX cycle value for paging (T3) (or not smaller than DRX cycle value for paging adaptation/clustering/bundling), procedure 1000 proceeds to operation 1035.

At operation 1030, UE 1002 does not apply the paging adaptation/clustering/bundling configuration. UE 1002 monitors paging based on the first paging configuration. UE 1002 determines its PF/PO for paging based on at least one of the first value of N, first value of Ns, first value of the paging frame offset (PF_offset) and the first value of firstPDCCH-MonitoringOccasionOfPO in the first paging configuration. UE 1002 determines the PDCCH monitoring occasions for paging based on first value of pagingSearchSpace.

$$T = min ( T 1 , T 2 and T 3 )$$

System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

UE 1002 monitors paging (i.e., a PDCCH addressed to P-RNTI) in the determined PO indicated by i_s. UE 1002 may monitor a PEI before a PO where PEI-O is determined based on firstPDCCH-MonitoringOccasionOfPEI-O in the first paging configuration.

At operation 1035, UE 1002 applies the paging adaptation/clustering/bundling configuration to determine a PO/PF. UE 1002 determines a PF/PO amongst the clustered/bundled PF/PO. UE 1002 monitors paging based on the second paging configuration. UE 1002 determines its PF/PO for paging based on at least one of the second value of N and second value of Ns in the second paging configuration. If the second value of the paging frame offset is configured in the second paging configuration, UE 1002 applies the second value of the paging frame offset to determine PF. Otherwise UE 1002 applies the first value of paging frame offset to determine PF. If the firstPDCCH-MonitoringOccasionOfPO is configured in the second paging configuration, UE 1002 applies it to determine a PO. Otherwise, UE 1002 applies the firstPDCCH-MonitoringOccasionOfPO (if configured) in first paging configuration to determine a PO. In an alternate embodiment, If the firstPDCCH-MonitoringOccasionOfPO is not configured in the second paging configuration, UE 1002 does not apply firstPDCCH-MonitoringOccasionOfPO to determine a PO. When firstPDCCH-MonitoringOccasionOfPO is applied to determine a PO, the starting PDCCH monitoring occasion number of (i_s+1)^{th}PO is the (i_s+1)^{th}value of the firstPDCCH-MonitoringOccasionOfPO parameter; otherwise, it is equal to i_s*S*X. As explained earlier, a PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. If the second value of pagingSearchSpace is configured in the second paging configuration, UE 1002 applies the second value of pagingSearchSpace to determine the PDCCH monitoring occasions for paging. Otherwise, UE 1002 applies the first value of pagingSearchSpace to determine the PDCCH monitoring occasions for paging.

$$T = min ( T 1 , T 2 and T 3 ) or T 3 or max ( T 1 , T 2 , T 3 )$$

System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

UE 1002 monitors paging (i.e., a PDCCH addressed to a P-RNTI) in the determined PO indicated by i_s. UE 1002 may monitor a PEI before a PO where PEI-O is determined based on firstPDCCH-MonitoringOccasionOfPEI-O (if configured) in the second paging configuration.

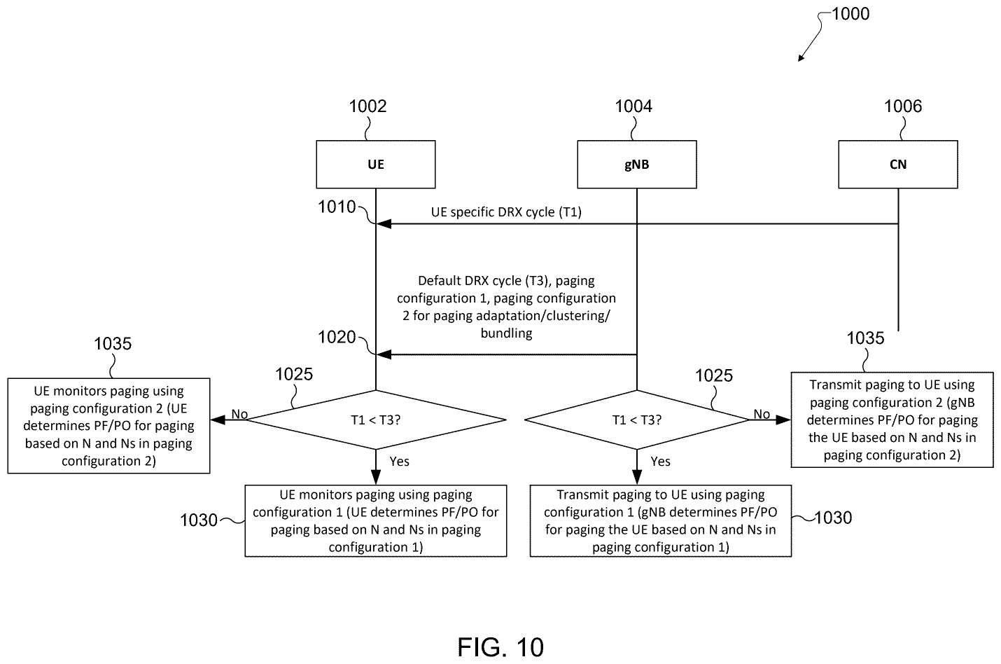

FIG. 11 illustrates another example procedure 1100 to transmit and receive paging according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of to transmit and receive paging could be used without departing from the scope of this disclosure.

In the example of FIG. 11, procedure 1100 begins at operation 1115. At operation 1115, a UE 1102 (which may be similar or identical to UE 116 of FIG. 1) may receive a UE specific DRX cycle value for paging (T2) from a gNB 1104. An RRC signaling message may be used to receive the UE specific DRX cycle value for paging. The UE specific DRX cycle value for paging may also be referred to as ran-PagingCycle and received in an RRCRelease message from the gNB 1004.

At operation 1120, UE 1102 may receive a default DRX cycle value for paging (T3) from system information transmitted by the camped cell. The default DRX cycle value for paging can also be referred to as defaultPagingCycle and received in the SIB (e.g., SIB1) of the camped cell in an RRC_IDLE/RRC_INACTIVE state or of the PCell in an RRC_CONNECTED state.

At operation 1120, UE 1102 may also receive a first paging configuration from the camped cell while in an RRC_IDLE/RRC_INACTIVE state or from the PCell in an RRC_CONNECTED state.

In some embodiments, the first paging configuration may include a first value of N (number of paging frames in DRX cycle T), first value of Ns (number of paging occasions per paging frame) and the first value of a paging frame offset. N, Ns and the paging frame offset of the first paging configuration can be received in the SIB (e.g., SIB1).

In some embodiments, the first paging configuration may include a first value of pagingSearchSpace.

In some embodiments, the first paging configuration may include firstPDCCH-MonitoringOccasionOfPO (firstPDCCH-MonitoringOccasionOfPO points out the first PDCCH monitoring occasion for paging of each PO of the PF).

In some embodiments, the first paging configuration may include firstPDCCH-MonitoringOccasionOfPEI-O (firstPDCCH-MonitoringOccasionOfPEI-O indicates the first PDCCH monitoring occasion of each PO of the PF).

some In embodiment,s firstPDCCH-MonitoringOccasionOfPO, firstPDCCH-MonitoringOccasionOfPEI-O, and pagingSearchSpace of the first paging configuration can be per BWP and received in a BWP configuration of a BWP in which UE 1102 receives paging. In these embodiments, firstPDCCH-MonitoringOccasionOfPO, firstPDCCH-MonitoringOccasionOfPEI-O, pagingSearchSpace of the first paging configuration for the intial BWP configuration is received in SIB (e.g., SIB1). firstPDCCH-MonitoringOccasionOfPO, firstPDCCH-MonitoringOccasionOfPEI-O, pagingSearchSpace of the first paging configuration for the BWP other than the intial BWP configuration is received in dedicated RRC signaling. In an RRC_IDLE/RRC_INACTIVE state, UE 1102 receives paging in an initial downlink BWP. In an RRC_CONNECTED state, UE 1102 receives paging in an active DL BWP, wherein the active DL BWP is the one of several BWPs configured to UE 1102. The active DL BWP can be an initial downlink BWP.

At operation 1120, UE 1102 may also receive a second paging configuration from the camped cell in an RRC_IDLE/RRC_INACTIVE state or from the PCell in an RRC_CONNECTED state. The second paging configuration is for paging based on paging adaptation/clustering/bundling.

In some embodiments, the second paging configuration may include a second value of N (number of paging frames in DRX cycle T), second value of Ns (number of paging occasions per paging frame), and second value of a paging frame offset. N, Ns and the paging frame offset of the second paging configuration can be received in the SIB (e.g., SIB1).

In some embodiments, the second paging configuration may include firstPDCCH-MonitoringOccasionOfPO (firstPDCCH-MonitoringOccasionOfPO points out the first PDCCH monitoring occasion for paging of each PO of the PF).

In some embodiments, the second paging configuration may include firstPDCCH-MonitoringOccasionOfPEI-O (firstPDCCH-MonitoringOccasionOfPEI-O indicates the first PDCCH monitoring occasion of each PO of the PF).

In some embodiments, the second paging configuration may include a second value of pagingSearchSpace.

In some embodiments, firstPDCCH-MonitoringOccasionOfPO, firstPDCCH-MonitoringOccasionOfPEI-O, pagingSearchSpace of the second paging configuration can be per BWP and received in a BWP configuration of a BWP in which UE 1102 receives paging. In these embodiments, firstPDCCH-MonitoringOccasionOfPO, firstPDCCH-MonitoringOccasionOfPEI-O, and pagingSearchSpace of the second paging configuration for the intial BWP configuration is received in a SIB (e.g., SIB1). firstPDCCH-MonitoringOccasionOfPO, firstPDCCH-MonitoringOccasionOfPEI-O, and pagingSearchSpace of the second paging configuration for the BWP other than the initial BWP configuration is received in dedicated RRC signaling. In an RRC_IDLE/RRC_INACTIVE state, UE 1102 receives paging in an initial downlink BWP. In an RRC_CONNECTED state, UE 1102 receives paging in active DL BWP wherein active DL BWP is the one of several BWPs configured to UE. active DL BWP can be initial downlink BWP.

At operation 1125, UE 1102 determines if the UE specific DRX cycle value for paging (T2) is smaller than the default DRX cycle value for paging (T3) (or smaller than the DRX cycle value for paging adaptation/clustering/bundling). This operation may be performed in an RRC_INACTIVE state if a UE specific value for paging T1 is not received (e.g., similar as described regarding operation 915 of procedure 900) and only T2 is received by UE 1102. If the UE specific DRX cycle value for paging (T2) is smaller than the default DRX cycle value for paging (T3) (or smaller than the DRX cycle value for paging adaptation/clustering/bundling), procedure 1100 proceeds to operation 1130. Otherwise, if the UE specific DRX cycle value for paging (T2) is not smaller than the default DRX cycle value for paging (T3) (or not smaller than the DRX cycle value for paging adaptation/clustering/bundling), procedure 1100 proceeds to operation 1135.

At operation 1130, UE 1102 does not apply the paging adaptation/clustering/bundling configuration. UE 1102 monitors paging based on the first paging configuration. UE 1102 determines its PF/PO for paging based on at least one of the first value of N, first value of Ns, first value of the paging frame offset (PF_offset) and the first value of firstPDCCH-MonitoringOccasionOfPO in the first paging configuration. UE 1102 determines the PDCCH monitoring occasions for paging based on first value of pagingSearchSpace.

$$T = min ( T 1 , T 2 and T 3 )$$

System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

UE 1102 monitors paging (i.e., a PDCCH addressed to P-RNTI) in the determined PO indicated by i_s. UE 1102 may monitor a PEI before a PO where PEI-O is determined based on firstPDCCH-MonitoringOccasionOfPEI-O in the first paging configuration.

At operation 1135, UE 1102 applies the paging adaptation/clustering/bundling configuration. UE 1102 determines a PF/PO amongst the clustered/bundled PF/PO. UE 1102 monitors paging based on the second paging configuration. UE 1102 determines its PF/PO for paging based on at least one of the second value of N and second value of Ns in the second paging configuration. If the second value of the paging frame offset is configured in the second paging configuration, UE 1102 applies the second value of the paging frame offset to determine PF. Otherwise UE 1102 applies the first value of paging frame offset to determine PF. If the firstPDCCH-MonitoringOccasionOfPO is configured in the second paging configuration, UE 1102 applies it to determine a PO. Otherwise, UE 1102 applies the firstPDCCH-MonitoringOccasionOfPO (if configured) in first paging configuration to determine a PO. In an alternate embodiment, If the firstPDCCH-MonitoringOccasionOfPO is not configured in the second paging configuration, UE 1102 does not apply firstPDCCH-MonitoringOccasionOfPO to determine a PO. When firstPDCCH-MonitoringOccasionOfPO is applied to determine a PO, the starting PDCCH monitoring occasion number of (i_s+1)^{th}PO is the (i_s+1)^{th}value of the firstPDCCH-MonitoringOccasionOfPO parameter; otherwise, it is equal to i_s*S*X. As explained earlier, a PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. If the second value of pagingSearchSpace is configured in the second paging configuration, UE 1102 applies the second value of pagingSearchSpace to determine the PDCCH monitoring occasions for paging. Otherwise, UE 1102 applies the first value of pagingSearchSpace to determine the PDCCH monitoring occasions for paging.

$$T = min ( T 1 , T 2 and T 3 ) or T 3 or max ( T 1 , T 2 , T 3 )$$

System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

UE 1102 monitors paging (i.e., a PDCCH addressed to a P-RNTI) in the determined PO indicated by i_s. UE 1102 may monitor a PEI before a PO where PEI-O is determined based on firstPDCCH-MonitoringOccasionOfPEI-O (if configured) in the second paging configuration.

Although FIG. 11 illustrates one example procedure 1100 to transmit and receive paging, various changes may be made to FIG. 11. For example, while shown as a series of operations, various operations in FIG. 11 could overlap, occur in parallel, occur in a different order, occur any number of times, be omitted, or replaced by other operations.

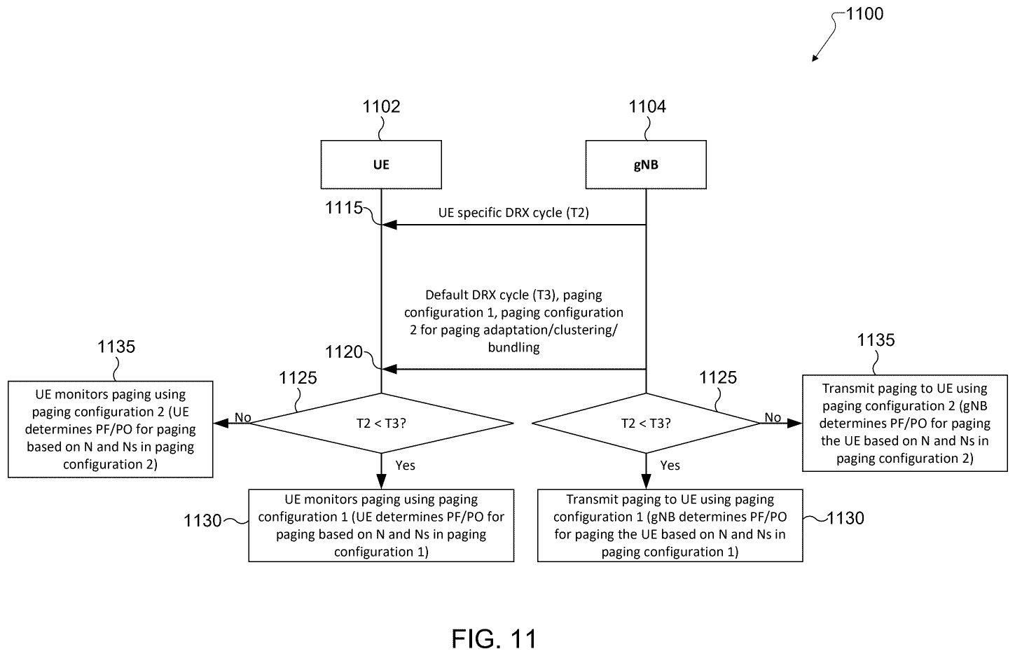

FIG. 12 illustrates an example method 1200 for small data transmission according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for small data transmission could be used without departing from the scope of this disclosure.

In the example of FIG. 12, method 1200 begins at step 1210. At step 1210, a UE (such as UE 116 of FIG. 1) receives, from a BS (such as gNB 102 of FIG. 1), a PUCCH configuration for SDT. The PUCCH configuration for SDT configures one or more PUCCH resources.

At step 1220, the UE determines whether each of at least one criterion to initiate an SDT procedure is met. If each of the at least one criterion to initiate an SDT procedure is met, the UE performs steps 1230-1240. In some embodiments, to determine whether each of the at least one criterion to initiate an SDT procedure is met, the UE may determine whether the UE has a valid TA, and in response to a determination that the UE fails to have a valid TA, determine that each of the at least one criterion to initiate the SDT procedure is not met.

At step 1230, the UE selects a PUCCH resource from the one or more PUCCH resources. In some embodiments, to select the PUCCH resource from the one or more PUCCH resources, the UE may select an SSB from a plurality of SSBs transmitted by the BS, and select the PUCCH resource from the one or more PUCCH resources based on a correspondence between the selected PUCCH resource and the selected SSB. In some embodiments, the UE may select the SSB from the plurality of SSBs based on an SS-RSRP of the selected SSB exceeding a threshold. In some embodiments, the UE may select any SSB from the plurality of SSBs when no SSB from the plurality of SSBs has a SS-RSRP exceeding a threshold.

At step 1240, the UE transmits, to the BS, an SDT initiation indication in the selected PUCCH resource.

In some embodiments, after transmitting the SDT initiation indication, the UE may (i) monitor a PDCCH for DCI addressed to C-RNTI, (ii) receive first DCI addressed to the C-RNTI, (iii) transmit UL data in an UL grant scheduled by the first DCI, (iv) receive second DCI addressed to the C-RNTI, and (v) receive DL data in a DL TB scheduled by the second DCI.

In some embodiments, the UE may receive, from the BS, a CG configuration for SDT, and after transmitting the SDT initiation indication, transmit UL data in a CG configured by the CG configuration for SDT.

Although FIG. 12 illustrates one example method 1200 for small data transmission, various changes may be made to FIG. 12. For example, while shown as a series of steps, various steps in FIG. 12 could overlap, occur in parallel, occur in a different order, occur any number of times, be omitted, or replaced by other steps.

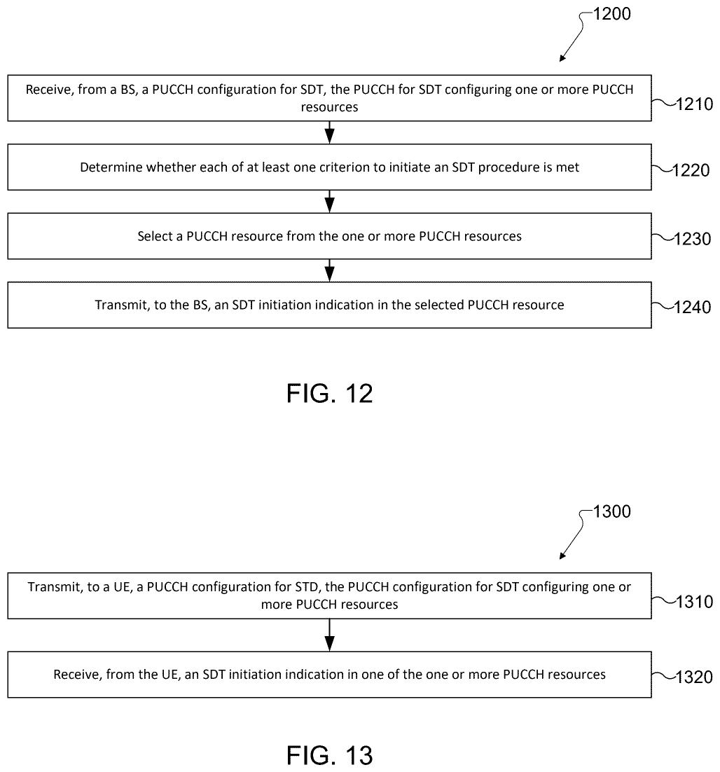

FIG. 13 illustrates another example method 1300 for small data transmission according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for small data transmission could be used without departing from the scope of this disclosure.

In the example of FIG. 13, method 1300 begins at step 1310. At step 1310, a BS (such as gNB 102 of FIG. 1) transmits, to a UE (such as UE 116 of FIG. 1), a PUCCH configuration for SDT. The PUCCH configuration for SDT configures one or more PUCCH resources.

At step 1320, the BS receives, from the UE, an SDT indication in one of the one or more PUCCH resources.

In some embodiments, the BS may transmit a plurality of SSBs, and one or more PUCCH resources in the PUCCH configuration for SDT may be associated with one or more SSBs from the plurality of SSBs. In some embodiments, the SDT indication is received in one of the PUCCH resources associated with one or more SSBs from the plurality of SSBs

In some embodiments, after receiving the SDT initiation indication, the BS may (i) transmit first DCI addressed to a C-RNTI, (iii) receive UL data in an UL grant scheduled by the first DCI, (iii) transmit second DCI addressed to the C-RNTI, and (iv) transmit DL data in a DL TB scheduled by the second DCI.

In some embodiments, the BS may transmit, to the UE, a CG configuration for SDT, and after receiving the SDE initiation indication, receive UL data in a CG configured by the CG configuration for SDT.

In some embodiments, the BS may receive the SDT initiation indication from the UE when the UE has a valid TA.

Although FIG. 13 illustrates one example method 1300 for small data transmission, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), a physical uplink control channel (PUCCH) configuration for small data transmission (SDT), the PUCCH configuration for SDT configuring one or more PUCCH resources; and
a processor operably coupled to the transceiver, the processor configured to:
determine whether each of at least one criterion to initiate an SDT procedure is met; and
in response to a determination that each of the at least one criterion to initiate the SDT procedure is met:
select a PUCCH resource from the one or more PUCCH resources; and
cause the transceiver to transmit, to the BS, an SDT initiation indication in the selected PUCCH resource.

2. The UE of claim 1, wherein to select the PUCCH resource from the one or more PUCCH resources, the processor is further configured to:
select a synchronization signal block (SSB) from a plurality of SSBs transmitted by the BS; and
select the PUCCH resource from the one or more PUCCH resources based on a correspondence between the selected PUCCH resource and the selected SSB.

3. The UE of claim 2, wherein to select the SSB from the plurality of SSBs, the processor is further configured to select the SSB from the plurality of SSBs based on a synchronization signal-reference signal received power (SS-RSRP) of the selected SSB exceeding a threshold.

4. The UE of claim 2, wherein to select the SSB from the plurality of SSBs, the processor is further configured to select any SSB from the plurality of SSBs as the selected SSB when no SSB from the plurality of SSBs has a synchronization signal-reference signal received power (SS-RSRP) exceeding a threshold.

5. The UE of claim 1, wherein:
the processor is further configured to, after causing the transceiver to transmit the SDT initiation indication, monitor a physical downlink control channel (PDCCH) for downlink control information (DCI) addressed to a cell-radio network temporary identifier (C-RNTI); and
the transceiver is further configured to:
receive first DCI addressed to the C-RNTI;
transmit uplink (UL) data in an UL grant scheduled by the first DCI;
receive second DCI addressed to the C-RNTI; and
receive downlink (DL) data in a DL transport block (TB) scheduled by the second DCI.

6. The UE of claim 1, wherein the transceiver is further configured to:
receive, from the BS, a configured grant (CG) configuration for SDT; and
after transmitting the SDT initiation indication, transmit uplink (UL) data in a CG configured by the CG configuration for SDT.

7. The UE of claim 1, wherein to determine whether each of the at least one criterion to initiate an SDT procedure is met, the processor is further configured to:
determine whether the UE has a valid timing advance (TA); and
in response to a determination that the UE fails to have a valid TA, determine that each of the at least one criterion to initiate the SDT procedure is not met.

8. A base station (BS) comprising:
a processor; and
a transceiver operably coupled to the processor, the transceiver configured to:
transmit, to a user equipment (UE), a physical uplink control channel (PUCCH) configuration for small data transmission (SDT), the PUCCH configuration for SDT configuring one or more PUCCH resources; and
receive, from the UE, an SDT initiation indication in one of the one or more PUCCH resources.

9. The BS of claim 8, wherein:
the transceiver is further configured to transmit a plurality of synchronization signal blocks (SSBs); and
one or more PUCCH resources in the PUCCH configuration for SDT are associated with one or more SSBs from the plurality of SSBs.

10. The BS of claim 8, wherein the SDT indication is received in one of the PUCCH resources associated with one or more SSBs from the plurality of SSBs.

11. The BS of claim 8, wherein the transceiver is further configured to:
after receiving the SDT initiation indication:
transmit first downlink control information (DCI) addressed to a cell-radio network temporary identifier (C-RNTI);
receive uplink (UL) data in an UL grant scheduled by the first DCI;
transmit second DCI addressed to the C-RNTI; and
transmit downlink (DL) data in a DL transport block (TB) scheduled by the second DCI.

12. The BS of claim 8, wherein the transceiver is further configured to:
transmit, to the UE, a configured grant (CG) configuration for SDT; and
after receiving the SDT initiation indication, receive uplink (UL) data in a CG configured by the CG configuration for SDT.

13. The BS of claim 8, wherein the SDT initiation indication is received from the UE when the UE has a valid timing advance (TA).

14. A method of operating a user equipment (UE), the method comprising:
receiving, from a base station (BS), a physical uplink control channel (PUCCH) configuration for small data transmission (SDT), the PUCCH configuration for SDT configuring one or more PUCCH resources;
determining whether each of at least one criterion to initiate an SDT procedure is met; and
in response to a determination that each of the at least one criterion to initiate the SDT procedure is met:
selecting a PUCCH resource from the one or more PUCCH resources; and
transmitting, to the BS, an SDT initiation indication in the selected PUCCH resource.

15. The method of claim 14, wherein to select the PUCCH resource from the one or more PUCCH resources, the method further comprises:
selecting a synchronization signal block (SSB) from a plurality of SSBs transmitted by the BS; and
selecting the PUCCH resource from the one or more PUCCH resources based on a correspondence between the selected PUCCH resource and the selected SSB.

16. The method of claim 15, wherein the SSB is selected from the plurality of SSBs based on a synchronization signal-reference signal received power (SS-RSRP) of the selected SSB exceeding a threshold.

17. The method of claim 15, wherein any SSB from the plurality of SSBs may be selected when no SSB from the plurality of SSBs has a synchronization signal-reference signal received power (SS-RSRP) exceeding a threshold.

18. The method of claim 14, further comprising:
after transmitting the SDT initiation indication, monitoring a physical downlink control channel (PDCCH) for downlink control information (DCI) addressed to a cell-radio network temporary identifier (C-RNTI);
receiving first DCI addressed to the C-RNTI;
transmitting uplink (UL) data in an UL grant scheduled by the first DCI;
receiving second DCI addressed to the C-RNTI; and
receiving downlink (DL) data in a DL transport block (TB) scheduled by the second DCI.

19. The method of claim 14, further comprising:
receiving, from the BS, a configured grant (CG) configuration for SDT; and
after transmitting the SDT initiation indication, transmitting uplink (UL) data in a CG configured by the CG configuration for SDT.

20. The method of claim 14, wherein to determine whether each of the at least one criterion to initiate an SDT procedure is met, the method further comprises:
determining whether the UE has a valid timing advance (TA); and
in response to a determination that the UE fails to have a valid TA, determining that each of the at least one criterion to initiate the SDT procedure is not met.
